(19) United States
(12) Patent Application Publication
(10) Pub. No.: US 2025/0374091 A1
(43) Pub. Date: Dec. 4, 2025

(54) FORWARDING CONTROL METHOD, INFORMATION TRANSMISSION METHOD, REPEATER AND NETWORK DEVICE

(71) Applicant: FUJITSU LIMITED, Kawasaki-shi (JP)

(72) Inventors: Qinyan JIANG, Beijing (CN); Lei ZHANG, Beijing (CN)

(73) Assignee: FUJITSU LIMITED, Kawasaki-shi (JP)

(21) Appl. No.: 19/304,643

(22) Filed: Aug. 20, 2025

Related U.S. Application Data
(63) Continuation of application No. PCT/CN2023/078007, filed on Feb. 23, 2023.

(51) Int. Cl. H04W 24/04; H04W 72/044; H04W 74/0833

(52) U.S. Cl. CPC H04W 24/04; H04W 72/046; H04W 74/0833

(57) ABSTRACT

Embodiments of this disclosure provide a forwarding control method, an information transmission method, a repeater and a network device. The repeater includes: a mobile termination configured to perform beam failure detection; and a forwarding entity configured to be turned off/not to perform forwarding in case of beam failure.

### CROSS-REFERENCE TO RELATED APPLICATION

This application is a continuation application under 35 U.S.C. 111(a) of International Patent Application PCT/CN2023/078007 filed on Feb. 23, 2023, and designated the U.S., the entire contents of which are incorporated herein by reference.

### TECHNICAL FIELD

This disclosure relates to the field of communication technologies.

### BACKGROUND

Compared with legacy 3G (third generation mobile communication technology) and 4G (fourth generation mobile communication technology) systems, a 5G (fifth generation mobile communication technology) system can provide larger bandwidths and higher data rates, and is able to support more types of terminals and vertical services.

For this reason, 5G systems are also deployed at new spectra in addition to legacy telecommunications spectra, and frequencies of the spectra are obviously higher than those of legacy telecommunications spectra used in 3G and 4G systems. For example, a 5G system may be deployed in a millimeter waveband (such as 28 GHz, 38 GHz, 60 GHz, and higher wavebands).

According to the principle of propagation of wireless signals, the higher a carrier frequency, the more severe a fading experienced by signals during transmission. Therefore, in actual deployment, a 5G system needs a cell coverage enhancement method more than 3G and 4G systems need, especially a 5G system deployed in a millimeter waveband. Hence, how to better enhance cell coverage of a 5G system has become an urgent problem to be solved.

In order to better solve the coverage problem of cellular mobile communication systems in practical deployment, use of a radio frequency (RF) relay/repeater to amplify and forward signals between a terminal equipment (UE) and a network device is commonly used means of deployment. RF repeaters are widely used in actual deployment of 3G and 4G systems. Generally speaking, an RF repeater is a device that amplifies and forwards signals between devices in the RF domain. That is, an RF repeater is a non-regenerative relay node, which only directly amplifies and forwards all received signals.

However, legacy RF repeaters are incapable of exchanging information with other devices (e.g. network devices/terminal equipments, etc.). Specifically, in terms of reception, legacy RF repeaters do not support measurement/demodulation/decoding of forwarded signals, nor do they receive signals other than the forwarded signals. In terms of transmission, legacy RF repeaters merely amplify and forward signals, and do not support generating signals and transmitting signals generated by themselves. Therefore, forwarding behaviors of legacy RF repeaters are not controlled by the network (e.g. via network devices, etc.).

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

A network controlled repeater (NCR) scheme is proposed in 3GPP Rel-18 to enhance NR coverage, so as to forward signals between a network device and a terminal equipment. NCR may directly communicate with the network device via control links to assist in forwarding operations of the NCR.

ON/OFF of legacy repeaters are typically manually set, which are unable to dynamically match data transmission between network devices and UEs. In general, data transmission does not occur constantly between network devices and terminal equipments. If the repeater remains ON even when there is no data transmission between a network device and a terminal equipment, unnecessary power consumption will be increased on one hand, and on the other hand, interference to other devices may be caused, thereby reducing network throughput. Therefore, compared to legacy repeaters, NCR needs to have a function of controlling the ON/OFF of a forwarding entity. When the NCR is in the ON state, the NCR may forward signals. However, whether/how an NCR performs forwarding in a case where a beam failure is detected has not been proposed yet.

In order to solve at least one of the above problems, embodiments of this disclosure provide a forwarding control method, an information transmission method, a repeater and a network device.

According to one aspect of the embodiments of this disclosure, there is provided a repeater, including:
a mobile termination configured to perform beam failure detection; and
a forwarding entity configured to be turned off/not to perform forwarding in case of beam failure.

According to another aspect of the embodiments of this disclosure, there is provided a network device, including:
a transmitting unit configured to transmit third indication information, wherein the third indication information is not transmitted before a repeater has an (applicable) backhaul link beam or a second time period before the repeater has an (applicable) backhaul link beam.

According to a further aspect of the embodiments of this disclosure, there is provided a communication system, including the repeater as described in the one aspect and/or the network device as described in the other aspect.

An advantage of the embodiments of this disclosure exists in that in the case where a beam failure is detected, the NCR may perform forwarding or does not perform forwarding; hence, time domain resources/beams to which the ON state of the forwarding entity corresponds may match with time domain resources/beams of data transmission between the network device and the terminal equipment, thereby saving power consumption of the repeater, reducing interference, and improving network throughput.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/comprising/include/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is a schematic diagram of a communication system of embodiments of this disclosure;

FIG. 2 is a schematic diagram of a forwarding control method of embodiments of this disclosure;

FIG. 3 is another schematic diagram of the forwarding control method of the embodiments of this disclosure;

FIG. 4 is a further schematic diagram of the forwarding control method of the embodiments of this disclosure;

FIG. 5 is still another schematic diagram of the forwarding control method of the embodiments of this disclosure;

FIG. 6 is a schematic diagram of an electronic device of embodiments of this disclosure;

FIG. 7 is a schematic diagram of a repeater of embodiments of this disclosure;

FIG. 8 is a schematic diagram of an information transmission method of embodiments of this disclosure;

FIG. 9 is a schematic diagram of a network device of embodiments of this disclosure;

FIGS. 10A-10E are schematic diagrams of a random access procedure of embodiments of this disclosure;

FIG. 11 is a schematic diagram of a first MAC CE of embodiments of this disclosure;

FIG. 12 is a schematic diagram of a second MAC CE of the embodiments of this disclosure;

FIG. 13 is a schematic diagram of a third MAC CE of the embodiments of this disclosure; and

FIG. 14 is a schematic diagram of a forwarding control method of embodiments of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” refers to, for example, an equipment accessing to a communication network and receiving network services via a network device, and may also be referred to as “a terminal equipment (TE)”. The terminal equipment may be fixed or mobile, and may also be referred to as a mobile station (MS), a terminal, a subscriber station (SS), an access terminal (AT), an IAB-MT, or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

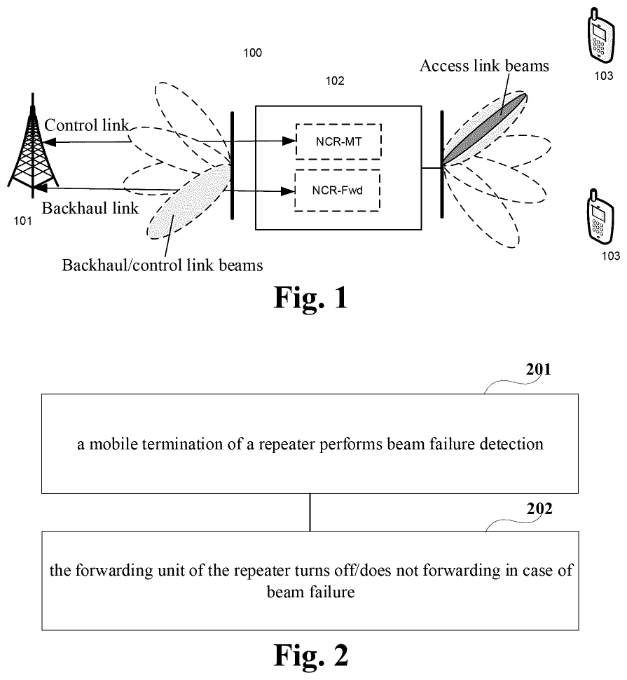

FIG. 1 is schematic diagram of an NCR of an embodiment of this disclosure. As shown in FIG. 1, NCR 102 is configured between a network device 101 and a terminal equipment 103. NCR 102 may include the following two modules/components: a mobile termination of the repeater (NCR-MT) and a forwarding entity of the repeater (NCR-Fwd). The NCR-Fwd may also be referred to as a routing unit of the NCR (NCR-RU). The NCR-MT is used for communication with the network device (information exchange), the NCR-Fwd is used for forwarding signals between the network device and the terminal equipment, and the NCR-MT and NCR-Fwd are functional entities, with functions thereof being implemented by identical or different hardware modules.

As shown in FIG. 1, the NCR of the embodiment of this disclosure may have three links: a control link (C-link), a backhaul link (BH link) for forwarding, and an access link (AC link, also referred to as an NCR-UE link), wherein the C-link is used for communication between the NCR and the network device, the BH link is used by the repeater to receive signals to be forwarded from the network device, or forward signals from the terminal equipment to the network device, and the AC link is used by the repeater to forward signals from the network device to the terminal equipment, or receive signals to be forwarded from the terminal equipment. Specifically, the NCR-MT communicates with the network device via the C-link, and the NCR-Fwd forwards signals via the BH link and the AC link.

In the embodiments of this disclosure, the repeater may communicate with the network device, receive communication channels/signals transmitted by the network device, and demodulate/decode the channels/signals to obtain information transmitted by the network device to the repeater. A signal processing process is hereinafter referred to as “communication”. The repeater may also forward channels/signals transmitted between the network device and the terminal equipment, does not demodulate/decode the channels/signals, and may perform amplification, etc. A signal processing process is hereinafter referred to as “forwarding”, and “communication” and “forwarding” are collectively referred to as “transfer”. In addition, ‘performing transmission or reception on the AC link (or the BH link)’ may be equivalent to ‘performing forwarding on the AC link (or the BH link)’, and ‘performing transmission or reception on the control link’ may be equivalent to ‘performing communication on the control link’. The above terms are for convenience of explanation only, and are not intended to limit this disclosure. In some cases, “a forwarding entity” and “a forwarding behavior” may be replaced with each other.

In the embodiments of this disclosure, the repeater may also be expressed as a network-controlled repeater (NCR), a radio frequency repeater, a relay, a radio frequency relay; or, it may also be expressed as a repeater node, or a relay node; or, it may also be expressed as an intelligent repeater, an intelligent relay, an intelligent repeater node, an intelligent relay node, etc.; however, this disclosure is not limited thereto.

In the embodiments of this disclosure, the network device may be a device of a serving cell of the terminal equipment, or a device in a cell where the repeater is located, or a device of a serving cell of the repeater, or a parent node of the repeater. Names of the repeater are not limited in this disclosure, and any device able to achieve the above functions is included in the scope of the repeater of this disclosure.

In the embodiments of this disclosure, higher-layer signaling may be, for example, radio resource control (RRC) signaling; for example, it includes an RRC message, which includes a master information block (MIB), system information, and a dedicated RRC message; or, it is an RRC information element (RRC IE); or an information field (or an information field included in an information field) included in an RRC message or an RRC information element. Higher-layer signaling may also be, for example, medium access control (MAC) signaling, or referred to as an MAC control element (MAC CE); however, this disclosure is not limited thereto.

In the embodiments of this disclosure, multiple means at least two, or two or more than two.

In the embodiments of this disclosure, “predefined” means defined in a protocol or determined according to a rule defined in a protocol, without needing additional configuration. Configuration/indication refer(s) to configuring/indicating directly or indirectly by a network device via higher-layer signaling and/or physical layer signaling. The physical layer signaling refers to, for example, control information (DCI) carried by a physical control channel or control information carried by a sequence. However, it is not limited thereto, and configuration/indication may be performed by introducing a higher-layer parameter into the higher-layer signaling, the higher-layer parameter referring to an information field and/or an information element (IE) in the higher-layer signaling.

Implementations of the embodiments of this disclosure shall be described below with reference to the accompanying drawings. These implementations are illustrative only, and are not intended to limit this disclosure.

Following description shall be given with reference to embodiments.

### Embodiments of a First Aspect

The embodiments of this disclosure provide a forwarding control method, which shall be described from a repeater side.

FIG. 2 is a schematic diagram of the forwarding control method of the embodiments of this disclosure. As shown in FIG. 2, the method includes:

201: a mobile termination of a repeater performs beam failure detection; and

202: the forwarding entity of the repeater turns off does not forwarding in case of beam failure.

It should be noted that FIG. 2 only schematically illustrates the embodiments of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 2.

In some embodiments, both the mobile termination of the repeater (hereinafter referred to as an NCR-MT) and the forwarding entity of the repeater (NCR-Fwd) are functional entities in the repeater, and both the mobile termination of the repeater and the forwarding entity of the repeater may be referred to as repeaters.

In some embodiments, the NCR-MT includes one serving cell (Pcell) or multiple serving cells, and the mobile termination of the repeater performs beam failure detection for a first cell, which is a primary cell (Pcell) or a PScell or an Scell, and the embodiments of this disclosure are not limited thereto.

In some embodiments, the NCR-MT performs BFD for the first cell, the network device configures reference signals (SSBs or CSI-RSs) for beam failure detection for the NCR, and before expiration of a configured timer, when the number of beam failure instances from a physical layer reaches (greater than or equal to) a configured threshold (BFI_COUNTER>=beamFailureInstanceMaxCount), it is determined that a beam failure occurs (that is, a beam failure is detected, including BFI_COUNTER>=beamFailureInstanceMaxCount), wherein, SSB-based beam failure detection is based on SSBs associated with an initial DL-BWP, and may be configured for the initial DL-BWP and a DL-BWP containing the SSBs associated with the initial DL-BWP. For other DL-BWPs, beam failure detection may only be performed based on CSI-RSs.

For example, a beam failure is detected by counting beam failure instances from a lower layer (physical layer) (by (an MAC entity of) the NCR/NCR-MT), wherein BFI_COUNTER (a first counter) is used to count beam failure instances, and its initial value is 0. For the first cell, if the MAC entity receives the beam failure instances from the lower layer (physical layer), beamFailureDetectionTimer is started and BFI_COUNTER is incremented by 1. When the value of BFI_COUNTER is greater than or equal to the configured threshold beamFailureInstanceMaxCount, if the first cell is an SCell, beam failure recovery by the NCT-MT for the first cell is triggered; otherwise, a random access procedure is performed on an SpCell (including a Pcell and/or a PScell, first cell). If beamFailureDetectionTimer expires or if an upper layer associated with the first cell reconfigures beamFailureDetectionTimer, a threshold or reference signals for BFD, BFI_COUNTER is set to be 0.

In some embodiments, in case of beam failure (such as including when a beam failure is detected and/or after a beam failure is detected (in the first cell), which shall not be repeated below any further), the method may further include: the repeater (NCR/NCR-MT) performs beam failure recovery (BFR), such as performing BFR for the first cell.

For example, the beam failure recovery includes: performing random access, such as performing random access on the first cell, the random access being random access for beam failure recovery; or, transmitting an SR and/or an MAC CE for BFR (to a second cell, which is a serving cell). For example, when/after the beam failure is detected, the BFR procedure is used to indicate a new SSB or CSI-RS (to the network device), and the NCR performs random access according to beam failure recovery configuration information configured by the network device, including contention-free random access (CFRA RACH) or contention-based random access (CBRA RACH), such as including two times of exchange between the network device and the NCR-MT (4-step RA). In a first time of exchange, the NCR-MT initiates a random access request (MSG1, including transmitting a random access preamble, or transmitting a physical random access channel (PRACH)), and receives a random access response (MSG2) fed back by the network device. And in a second time of exchange, the NCR-MT transmits information (MSG3) including identifiers to the network device, and receives MSG4 fed back by the network device; or, the random access may also be 2-step random access (2-step RA), that is, original MSG1 and MSG3 are merged into a new MSGA, and MSG2 and MSG4 are merged into MSGB.

For a Pcell/PScell (SpCell): a random access procedure is initiated on the first cell (Pcell/PScell (SpCell)), and when a beam failure is detected on the Pcell/PScell (SpCell), the NCR triggers beam failure recovery by initiating a random access procedure on the Pcell/PScell (SpCell), and selects appropriate beams to perform beam failure recovery (if the network device has provided dedicated random access resources for certain beams, the NCR will give priority to these beams); and if the random access procedure involves contention-based random access, an indication of beam failure on the Pcell/PScell (SpCell) is included in a BFR MAC CE.

For an Scell (non-PScell): a beam failure is detected in the first cell (SCell), the beam failure recovery is triggered by initiating transmission of a BFR MAC CE for the SCell; appropriate beams (if available) are selected for the SCell and indicated in the BFR MAC CE together with information on the beam failure. Upon receipt of a PDCCH, which indicates an uplink grant (UL grant) for new transmission of an HARQ process for transmission of a BFR MAC CE, it is deemed that beam failure recovery of the SCell is completed.

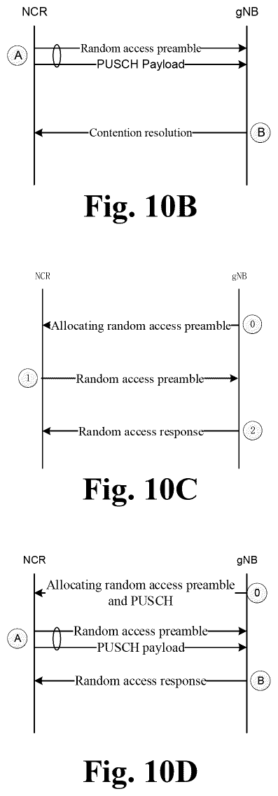

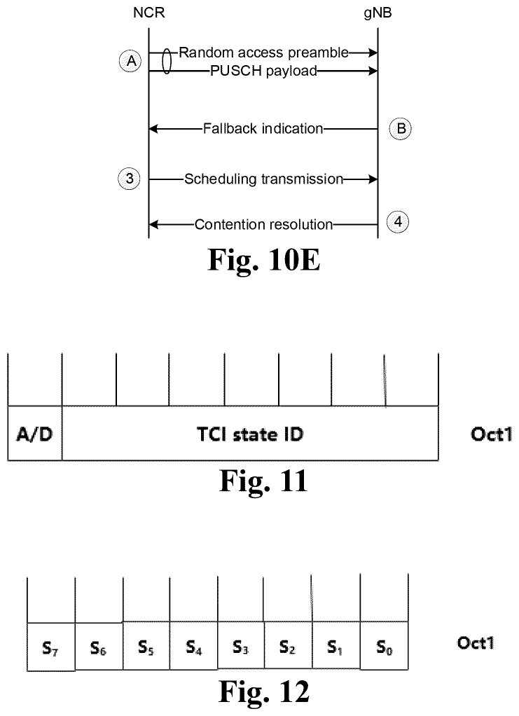

In some embodiments, regarding a random access procedure initiated for/due to BFR initialization: according to a configuration, the random access procedure includes 4-stepRA (4-step RA type) and/or 2-stepRA (2-step RA type) for contention-based random access, and/or 4-stepRA (4-step RA type) and/or 2-stepRA (2-step RA type) for contention-free random access. FIG. 10A is a schematic diagram of the CBRA of the 4-stepRA type of the embodiments of this disclosure. As shown in FIG. 10A, step 1 (MSG1): transmitting a random access preamble by the NCR to the network device; step 2 (MSG2): receiving an RAR fed back by the network device; step 3 (MSG3): transmitting scheduling transmission to the network device; and step 4 (MSG4): receiving a contention resolution message transmitted by the network device. FIG. 10B is a schematic diagram of the CBRA of the 2-stepRA type of the embodiments of this disclosure. As shown in FIG. 10B, the NCR transmits a random access preamble and a PUSCH payload (MSGA) to the network device, and receives a contention resolution message (MSGB) transmitted by the network device. FIG. 10C is a schematic diagram of the CFRA of the 4-stepRA type of the embodiments of this disclosure. As shown in FIG. 10C, the network device allocates a random access preamble (MSG0) to the NCR, and the NCR transmits a random access preamble (MSG1) to the network device, and then receives an RAR (MSG2) fed back by the network device. FIG. 10D is a schematic diagram of the CFRA of the 2-stepRA type of the embodiment of this disclosure. As shown in FIG. 10D, the network device allocates a random access preamble and a PUSCH (MSG0) to the NCR, and the NCR transmits a random access preamble and a PUSCH load (MSGA) to the network device, and then receives an RAR (MSG2) fed back by the network device.

In some embodiments, if the random access procedure of the 2-step RA type is still not completed after some MSGAs are transmitted, the NCR may be configured to switch to the CBRA of the 4-step RA type. FIG. 10E is a schematic diagram of the random access procedure of the embodiments of this disclosure. As shown in FIG. 10E, the NCR transmits the random access preamble and PUSCH payload (MSGA) to the network device, receives a FALLBACK indication, transmits scheduling transmission to the network device, and receives the contention resolution message transmitted by the network device.

For example, successful beam failure recovery includes that: for CFRA, the NCR-MT detects DCI (format) with CRC scrambled by a C-RNTI or an MCS-C-RNTI or an RNTI addressed to the NCR in a search space (SS, a first SS described later) provided by recoverySearchSpaceId (or, in other words, receives a PDCCH transmission at the SS, the PDCCH transmission being addressed to a C-RNTI or an MCS-C-RNTI or an RNTI for the NCR), and/or, receives a first PDCCH (the first PDCCH is addressed to a C-RNTI or an MCS-C-RNTI or an RNTI for the NCR, for example, in the CFRA, after the first PDCCH (NCR/NCR-MT) transmits MsgA or a PRACH, it is received during an RAR window), and/or, a (contention-free) random access procedure (in the beam failure recovery, or for the beam failure recovery, or for initialization of the beam failure recovery) is (successfully) completed (the Random Access procedure successfully completed), and/or the beam failure recovery is (successfully) completed. (For the CBRA,) The NCR-MT detects DCI (format) with CRC scrambled by a C-RNTI or an MCS-C-RNTI or an RNTI addressed to the NCR in a search space provided by recoverySearchSpaceId (or, in other words, receives a PDCCH transmission at the SS, the PDCCH transmission being addressed to a C-RNTI or an MCS-C-RNTI or an RNTI for the NCR), and/or, receives a first PDCCH (the first PDCCH is addressed to a C-RNTI or an MCS-C-RNTI or an RNTI for the NCR), for example, in the 2-step CBRA, after the first PDCCH (NCR/NCR-MT) transmits MsgA, in the 4-step CBRA, after the first PDCCH (NCR/NCR-MT) transmits Msg.3, it is received during a contention resolution RAR window), contention resolution is successful, and/or, a (contention-based) random access procedure (in the beam failure recovery, or for the beam failure recovery, or for initialization of the beam failure recovery) is (successfully) completed (Random Access procedure successfully completed), and/or the beam failure recovery is (successfully) completed.

The successful beam failure recovery shall be further described below.

In some embodiments, for the PCell or the PSCell, a CORESET through a link to a search space set provided by recoverySearchSpaceId, which is used to monitor PDCCHs in the CORESET (such as a first PDCCH; however, it is not limited thereto).

In some embodiments, in the case of CBRA/CFRA 4-step type: PDCCHs are monitored in ra-ResponseWindow, when the MAC entity transmits a contention-free random access preamble indicated for beam failure recovery, ra-Response Window in Beam Failure Recovery Configuration (BeamFailureRecoveryConfig) is started from a first PDCCH occasion when/after the end of transmission of the random access preamble, and PDCCH transmission (identified by the C-RNTI or MCS-C-RNTI or RNTI for the NCR) on a search space indicated by recovery SearchSpaceId of the SpCell is monitored when (during) ra-ResponseWindow is in operation.

In some embodiments, for the CFRA 4-step type, (in the above ra-ResponseWindow), that a corresponding PDCCH (first PDCCH, on the search space provided by recovery SearchSpaceId) is received means that the random access procedure is successful, or the beam failure recovery is successful. For example, when a notification of receiving the first PDCCH is received from the lower layer on a serving cell transmitting the random access preamble, the first PDCCH being addressed to the C-RNTI and the MAC entity transmits a contention-free random access preamble for a beam failure recovery request, it is deemed that the random access is successful, or that the beam failure recovery is successful.

In some embodiments, for the 4-step type of the CBRA, if valid downlink allocation for the RA-RNTI is received on a PDCCH (used to schedule a PDSCH carrying the RAR) and a received TB is successfully decoded, if a random access procedure is initiated for the beam failure recovery of the SpCell and SpCell BFR CBRA with a value that is true is configured, that subsequent uplink transmission includes a BFR MAC CE or a truncated BFR MAC CE is indicated to a multiplexing and assembly entity (transmitted in MSG3). An MAC PDU to be transmitted is obtained from the multiplexing and assembly entity and is stored in an MSG3 buffer.

In some embodiments, for the CBRA of the 4-step type, once MSG3 is transmitted, the MAC entity shall start ra-ContentionResolutionTimer, and restart ra-ContentionResolutionTimer at each HARQ retransmission in a first symbol after the end of MSG3 transmission, and monitor the PCCCH when ra-ContentionResolutionTimer is in operation (in the search space provided by recovery SearchSpaceId), regardless of measurement intervals that may possibly occur.

In some embodiments, for the CBRA of the 4-step type, when a notification of receiving the first PDCCH on the SpCell is received from a lower layer (or, in other words, a first PDCCH is received when ra ContentionResolutionTimer is in operation (in the search space provided by recovery SearchSpaceId), the previously transmitted MSG3 includes the MAC CE of the C-RNTI, the first PDCCH is addressed to the C-RNTI or MCS-C-RNTI or the RNTI for the NCR, and the random access procedure is initiated for the beam failure recovery of the SpCell, it is deemed that the random access procedure (contention resolution) is successful, or, in other words, the beam failure recovery is successful, recoverySearchSpaceId is stopped, and a temporary C-RNTI is discarded.

In some embodiments, for the 2-step type of the CFRA, a PCCCH is monitored in msgB-Response Window, a notification of receiving the first PCCCH on the SpCell is received from the lower layer (or, in other words, the first PCCCH is received (in msgB-ResponseWindow) (in the search space provided by recoverySearchSpaceId)), and the previously transmitted MSGA includes the MAC CE of the C-RNTI, it is deemed that the random access procedure is successful, or, in other words, that the beam failure recovery is successful, or, in other words, that the random access response is received successfully, and msgB-ResponseWindow is stopped.

In some embodiments, in case of beam failure (such as including when and/or after a beam failure is detected (in the first cell)), (it is expected that) the forwarding entity of the repeater is turned off/does not perform forwarding, or does not (is not allowed to) turn on/perform forwarding.

For example, in the case where beam failure occurs in the first cell, no forwarding is performed, until the BFR is successful. After the BFR is successful (until a new configuration is received/applied), a first beam is used for forwarding, and after the new configuration is received/applies, a second beam is used for forwarding; or, for example, after beam failure occurs in the first cell, (regardless of whether the BFR is successful or after the BFR is successful), until a new configuration is received and/or applied, no forwarding is performed (that is, after beam failure occurs in the first cell, even if the BFR is successful (or after the BFR is successful), until the new configuration is received and/or applied, no forwarding is performed). After the new configuration is received and/or applied, the first beam or the second beam or a third beam is used for forwarding, which shall be described below respectively.

(I) (It is expected that) the NCR-Fwd is turned off/does not perform forwarding (or is not allowed to turn on/perform forwarding), until the BFR is successful (or before the BFR is successful). That is, during the beam failure recovery (random access procedure), the NCR-Fwd does not perform forwarding, until the BFR is successful.

In some embodiments, after the BFR is successful, forwarding is performed at the NCR-Fwd by using the first beam.

In some embodiments, a first period of time after the first PDCCH (is received), forwarding is performed at the NCR-Fwd by using the first beam, for example, after first period of time after the first PDCCH (is received) is after 28 symbols from a last symbol of the first PDCCH (is received), wherein the first PDCCH (is received) is in a search space set provided by recovery SearchSpaceId and used for detecting DCI (format) (for example, the first PDCCH carries the DCI (format); however, it is not limited thereto) with CRC scrambled by a C-RNTI or MCS-C-RNTI. The first PDCCH is used to determine that the beam failure recovery is successful and/or is used to determine that the random access procedure is completed.

The first beam shall be described below. For example, the first beam is a backhaul link beam, which refers to a beam used by a backhaul link when the forwarding entity of the repeater performs forwarding or a beam used by a network device side of the repeater. That is, the forwarding entity of the repeater uses the first beam to forward signals to the network device, or forwards signals from the network device side (that is, it is used for a backhaul link or for forwarding) and/or the first beam is a control link beam (that is, it is used for a control link or for communication/information exchange between the NCR/NCR-MT and the network device).

In some embodiments, the first beam is identical to a beam used in a (recent) random access attempt/procedure (or a successful random access attempt/procedure) (in the beam failure recovery, or for the beam failure recovery, or for initialization of the beam failure recovery) (including a beam determined by (according to) an SSB associated with an RO (RACH occasion) where a recent PRACH transmission is located/used by the recent PRACH transmission). The first beam includes a downlink beam (or a receiving beam for receiving a downlink signal and/or channel from the network device (transmitted to the NCR/NCR-MT and/or to be forwarded (by the NCR/NCR-Fwd)) and/or an uplink beam (or a transmitting beam for transmitting an uplink signal and/or channel (of the NCR/NCR-MT and/or from the UE/forwarded by the NCR/NCR-Fwd)) to the network device.

For example, the first beam includes: same antenna port quasi-collocation parameters as the ones associated with index new, or a (downlink) beam determined by the QCL parameters, and/or, a same spatial filter as for the last PRACH transmission, or, an (uplink) beam determined by the spatial filter, and/or, (downlink and/or uplink) beams determined by (according to) an SSB associated with an RO (RACH occasion) of the last PRACH transmission (where last PRACH transmission is located/used), and/or a downlink beam for receiving the first PDCCH, and/or an uplink beam for transmitting the last PRACH transmission.

In some embodiments, the first beam is predefined (such as being defined in a protocol or being determined according to a predefined rule) or is indicated.

In some embodiments, the first beam is used for forwarding in a case where the NCR-MT/control link has or does not have reception or transmission.

In the above embodiment, after the BFR is successful, or a first period of time after the first PCCCH, until the first indication information (control link beam indication/configuration) and/or the second indication information (or backhaul link beam configuration/indication) and/or the third indication information (or access link beam configuration/indication) is/are received, and/or the first indication information and/or the second indication information and/or the third indication information is/are applied (or beams indicated by the above indication information are applied), the NCR-Fwd performs forwarding by using the first beam, or, after the BFR is successful, or a first period of time after the first PCCCH, before receiving the first indication information (control link beam indication/configuration) and/or the second indication information (or backhaul link beam configuration/indication) and/or the third indication information (or access link beam configuration/indication), and/or before applying the first indication information and/or the second indication information and/or the third indication information (or beams indicated by the above indication information), the NCR-Fwd performs forwarding by using the first beam.

In some embodiments, after receiving the first indication information (control link beam indication/configuration) and/or the second indication information (or backhaul link beam configuration/indication) and/or the third indication information (or access link beam configuration/indication) and/or applying the first indication information and/or the second indication information and/or the third indication information (or applying beams indicated by the above indication information) (or applying beams indicated by the above indication information), the NCR-Fwd performs forwarding by using the second beam.

In some embodiments, after receiving the first indication information (control link beam indication/configuration) and/or the second indication information (or backhaul link beam configuration/indication) and/or the third indication information (or access link beam configuration/indication) and/or applying the first indication information and/or the second indication information and/or the third indication information (or applying beams indicated by the above indication information) (or applying beams indicated by the above indication information), the NCR-Fwd performs forwarding by using the first beam or the third beam. For example, when there is no indication from the first indication information and the second indication information, but the third indication information indicates that the NCR may perform forwarding, the NCR performs forwarding by using a predefined first beam or a third beam described later.

In some embodiments, the above indications and the second beam and third beam shall be described later.

(II) (Regardless of whether the BFR is successful or not) until the first indication information (control link beam indication/configuration) and/or the second indication information (or backhaul link beam configuration/indication) and/or the third indication information (or access link beam configuration/indication) is/are received, and/or the first indication information and/or the second indication information and/or the third indication information (or beams indicated by the above indication information) is/are applied, (it is expected that) the NCR-Fwd is turned off/does not perform forwarding (or is not allowed to turn on/perform forwarding) before the beam failure recovery is successful.

Or, before the first indication information (control link beam indication/configuration) and/or the second indication information (or backhaul link beam configuration/indication) and/or the third indication information (or access link beam configuration/indication) is/are received, and/or the first indication information and/or the second indication information and/or the third indication information (or beams indicated by the above indication information) is/are applied, (it is expected that) the NCR-Fwd is turned off/does not perform forwarding (or is not allowed to turn on/perform forwarding) before the beam failure recovery is successful.

In some embodiments, after receiving the first indication information (control link beam indication/configuration) and/or the second indication information (or backhaul link beam configuration/indication) and/or the third indication information (or access link beam configuration/indication), and/or applying the first indication information and/or the second indication information and/or the third indication information (or applying beams indicated by the above indication information) (or applying beams indicated by the above indication information), the NCR-Fwd performs forwarding by using the second beam.

In some embodiments, after receiving the first indication information (control link beam indication/configuration) and/or the second indication information (or backhaul link beam configuration/indication) and/or the third indication information (or access link beam configuration/indication) and/or applying the first indication information and/or the second indication information and/or the third indication information (or applying beams indicated by the above indication information) (or applying beams indicated by the above indication information), the NCR-Fwd performs forwarding by using the first beam or the third beam. For example, when there is no indication from the first indication information and the second indication information, but the third indication information indicates that the NCR may perform forwarding, the NCR performs forwarding by using a predefined first beam or a third beam described later.

The indication information in (I) and (II) shall be described below.

In some embodiments, the first indication information is used to indicate/configure a control link beam.

For example, the first indication information is used to configure and/or activate TCI state/SRI (SpatialRelationInfo) (for PDSCHs and/or PDCCHs and/or PUCCHs and/or SRSs), and includes RRC signaling, and/or an MAC CE, and/or DCI. For example, the first indication information includes an MAC CE activation command for a TCI state (or an indication for activating a TCI state), or an information field of tci-StatesToAddModList (−r17/r18) and tci-StatesToReleaseList (−r17/r18) in PDSCH-Config; for example, the MAC CE may be a unified TCI states activation/deactivation MAC CE or a TCI states activation/deactivation user-specific PDSCH MAC CE, or a TCI state indication user-specific PDCCH MAC CE. And/or, the first indication information includes an (MAC CE) activation command for PUCCH-SpatialRelationInfo (−r17/r18) of PUCCH resources and/or for PUCCH-SpatialRelationInfo (−r17/r18). For example, the activation command includes a PUCCH spatial relation activation/deactivation MAC CE, or an enhanced PUCCH spatial relation activation/deactivation MAC CE, or a multi-TRP PUCCH repetition PUCCH spatial relation activation/deactivation MAC CE (a PUCCH spatial relation activation/deactivation MAC CE), and/or, tci-StatesToAddModList (−r17/r18) and/or tci-StatesToReleaseList (−r17/r18) (configured for PDCCHs/in PDSCH-Config), and/or, dl-OrJointTCI-StateList (−r17/r18) and/or dl-OrJointTCI-StateToAddModList (−r17/r18) and/or dl-OrJointTCI-StateToReleaseList (−r17/r18) (configured for PDCCHs/in PDSCH-Config), and/or, ul-TCI-ToAddModList, and/or, second DCI (e.g. DCI format 1_1/1_2, etc.) (used for indicating (or having indicated) a unified TCI).

In some embodiments, the second indication information is used to indicate a backhaul link beam.

For example, the second indication information is MAC signaling, wherein the second indication information is used to indicate a TCI state for a backhaul link from a first TCI state set, or indicate a TCI state for a backhaul link from a second TCI state set, or indicate an SRI for a backhaul link from a first SRI state set. For example, when the control link applies an Rel-15/16 beam indication framework, for a downlink beam, the second indication information indicates the TCI state used for the backhaul link from the first TCI state set, for an uplink beam, the second indication information indicates the SRI used for the backhaul link from the first SRI set, and when the control link applies an Rel-17 beam indication framework, the second indication information indicates the TCI state used for the backhaul link from the second TCI state set. Or, the second indication information indicates a unified TCI state. For example, for the NCR, a unified TCI state type must indicate uplink and downlink joint, and may indicate uplink and downlink joint or separate, wherein the separate denotes that the serving cell configures dl-OrJointTCI-StateList of a downlink TCI state and ul-TCI-ToAddModList of an uplink TCI state, and joint denotes that the serving cell configures dl-OrJointTCI-StateList of an uplink and downlink joint TCI state.

In some embodiments, the second indication information includes one or more MAC CEs.

For example, the second indication information includes a first MAC CE used to indicate a downlink beam of a backhaul link. When the control link applies the Rel-15/16 beam indication framework, for the downlink beam, the first MAC CE indicates the TCI state used for the backhaul link from the first TCI state set, at least includes a first information field for indicating a TCI state (e.g. a TCI state ID), and includes or does not include a second information field for indicating a serving cell (e.g. a serving cell ID) and/or a third information field for indicating a downlink BWP (e.g. a BWP ID).

For example, the second indication information includes a second MAC CE used to indicate an uplink beam of a backhaul link. When the control link applies the Rel-15/16 beam indication framework, for the uplink beam, the second MAC CE indicates the SRI used for the backhaul link from the first SRI set, at least includes a first information field for indicating an SRI (e.g. an SRI ID), and includes or does not include a second information field for indicating a serving cell (e.g. a serving cell ID) and/or a third information field for indicating a UL BWP (e.g. a BWP ID). For example, the first information field indicates the SRI for the backhaul link by indicating pucch-SpatialRelationInfoId.

For example, the second indication information includes a third MAC CE used to indicate an uplink beam and/or a downlink beam of a backhaul link. When the control link applies an Rel-17 beam indication framework, the third MAC CE indicates the TCI state used for the backhaul link from the second TCI state set, at least includes a first information field for indicating a TCI state (e.g. a TCI state ID), and includes or does not include a second information field for indicating a serving cell (e.g. a serving cell ID) and/or a third information field for indicating a BWP (e.g. a BWP ID). What is indicated by the first information field is a unified TCI state, such as indicating a TCI state for a backhaul link from dl-OrJointTCI-StateList.

The above first MAC CE, second MAC CE and third MAC CE may be identical MAC CEs or different MAC CEs, and the embodiment of this disclosure is not limited thereto.

For example, the first MAC CE (an NCR backhaul link downlink beam activation/deactivation MAC CE) is identified by an MAC subheader with eLCID (refer to Table 6.2.1-1b), and has a fixed size of 8 bits. FIG. 11 is a schematic diagram of the first MAC CE in the embodiments of this disclosure. As shown in FIG. 11, a TCI state ID field (7 bits) indicates TCI-StateID of a TCI state configured by tci-StatesToAddModList and tci-StatesToReleaseList in PDSCH-Config of an active BWP, and an A/D field (1 bit) indicates whether to activate or deactivate the indicated TCI state, and when the field is set to be 1, it indicates activation; otherwise, it indicates deactivation.

For example, the second MAC CE (NCR backhaul link uplink beam activation/deactivation MAC CE) is identified by an MAC subheader with eLCID (refer to Table 6.2.1-1b), and has a fixed size of 8 bits. FIG. 12 is a schematic diagram of the second MAC CE in the embodiments of this disclosure. As shown in FIG. 12, an Si information field is for activation BWP configuration PUCCH spatial relation information SpatialRelationInfoId (refer to TS 38.331), and denotes an active state of PUCCH SpatialRelationInfo, PUCCH SpatialRelationInfoID is equal to i+1. The Si field is set to be 1 for indicating that the PUCCH spatial relation information (SpatialRelationInfoId is equal to i+1) should be activated, and the Si field is set to be 0 for indicating that the PUCCH spatial relation information (SpatialRelationInfoId is equal to i+1) should be deactivated. One time of activation is only able to activate single PUCCH spatial relation information configured in an active BWP.

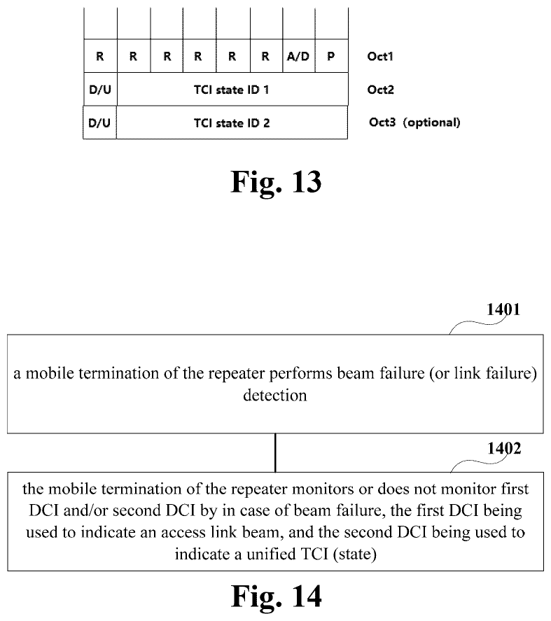

For example, the third MAC CE (NCR backhaul link unified beam activation/deactivation MAC CE) is identified by an MAC subheader with eLCID (refer to Table 6.2.1-1b), and has a variable size. FIG. 13 is a schematic diagram of the third MAC CE in the embodiments of this disclosure. As shown in FIG. 13,
P: this field indicates whether a TCI codepoint has two TCI states or a single TCI state. If the field P is set to be 1, it indicates that the TCI codepoint includes a DL TCI state and a UL TCI state, and if the field P is set to be 0, it indicates that the TCI codepoint includes only a DL/joint TCI state or a UL TCI state.
D/U: this field indicates that a TCI state ID in the same octet is used for a DL/joint TCI state or a UL TCI state. If this field is set to be 1, the TCI state ID in the same (corresponding) octet is used for a DL/joint TCI state, and if this field is set to be 0, the TCI state ID in the same (corresponding) octet is used for a UL TCI state.
TCI state ID: this field indicates a TCI identified by a TCI state ID configured in an active DL/UL BWP specified in TS 38.331. If D/U is set to be 1, a TCI state ID of a length of 7 bits is used, i.e. the TCI StateId configured in dl-OrJoint-TCStateList-r17 of an active DL BWP specified in TS 38.331, and if D/U is set to be 0, the most significant bit of the TCI state ID is deemed as a reserved bit, and remaining 6 bits indicate a UL TCIState ID configured in an active UL BWP specified in TS 38.331.
A/D: this field indicates whether to activate or deactivate an indicated TCI state. Setting this field to be 1 indicates activation; otherwise, it indicates deactivation.
R: a reserved bit, which is set to be 0.

In some embodiments, the third indication information is used to indicate an access link beam. The third indication information includes: a periodic/semi-static (or RRC signaling provided) access link beam indication (hereinafter referred to as a first beam indication information), an activation command (MAC CE/DCI) (for activating the access link beam indication), information for configuring/indicating (NCR monitoring) first DCI, and first DCI (for indicating the access link beam).

For example, the first beam indication information may be an information field (higher-layer parameter) newly introduced into RRC signaling, the new information field including one or more periodic beam indications (first beam indications) for the one or more access links. Each first beam indication includes a forwarding resource list, each of which including a fourth information field indicating the access link beam and a fifth information field indicating a time domain resource. The fifth information field includes duration information and/or offset information of the time domain resources within a period. Furthermore, the first beam indication may include period information (for all time domain resources indicated by the first beam indication information) and/or priority information. In addition, the first beam indication information may include the sixth information field for indicating a first subcarrier spacing. The indicated first subcarrier spacing is for all time domain resources indicated by the first beam indication information. For example, all the time domain resources indicated by the first beam indication information are related to the first subcarrier spacing, which includes that duration information and/or offset information of the time domain resources are in relation to the first subcarrier spacing. The duration information and/or offset information may be in units of milliseconds or slots or symbols, and lengths thereof are related to the first subcarrier spacing; however, the embodiments of this disclosure are not limited thereto.

In some embodiments, the network device may transmit one or more first beam indication information to the NCR, each first beam indication information including one or more of the above fourth information field, fifth information field, sixth information field, period information and priority information. For example, by using ToAddModList or other lists for configuration, one or more lists may be configured, wherein one list includes one of the above first beam indication information, hence, one or more of first beam indication information may be supported.

In some embodiments, the RRC signaling includes an RRC Reconfigure message, and/or an RRC Release message, and/or a first RRC message, wherein the first RRC message is an NCR-specific RRC message.

In some embodiments, the first RRC message may include other information in addition to the above first beam indication information, such as relevant configurations for a fourth information field and a fifth information field in the first DCI described later (such as a time domain resource list configuration described below, etc.); however, the embodiments of this disclosure are not limited thereto.

In some embodiments, after receiving the first beam indication information, the NCR needs further to receive another indication before starting to perform forwarding by using a corresponding access link beam in the corresponding indicated time domain resource according to the first beam indication information, or, after receiving the first beam indication information, the NCR may perform forwarding by using a corresponding access link beam in the corresponding indicated time domain resource according to the first beam indication information without needing to receive another indication.

In some embodiments, whether NCR supports the first beam indication information is optional (may support or may not support), or is mandatory (supporting), or is conditionally mandatory (such as supporting when a condition (e.g. operating frequency band FR2) is satisfied).

For example, the first DCI format is used for access link beam indication. Downlink control information in the first DCI format is not used for scheduling PDSCHs or PUSCHs, and may also be used for scheduling PDSCHs or PUSCHs. The first DCI format may be a newly-introduced DCI format (e.g. DCI format 2_8, or 2_9, or 2_10, etc.), or may be an existing DCI format (e.g. 1_1, or 2_0, etc.). The first DCI format is identical to or different from the second DCI format (the existing DCI formats still support functions in the embodiments of this disclosure), and the embodiments of this disclosure are not limited thereto.

In some embodiments, “downlink control information in the first DCI format” or “downlink control information using the first DCI format” or “DCI in the first DCI format” or “first DCI” may also be replaced with “first DCI format”.

For example, the third indication information may include one or more fourth information fields for indicating beams and one or more fifth information fields for indicating time domain resources, and the forwarding entity of the repeater does not perform forwarding outside a time domain resource indicated by the third indication information. For example, the third indication information is the first DCI, and one fourth information field is used to indicate one access link beam index, or indicate at most one access link beam index, or indicate multiple access link beam indices. The access link beam index may include a beam index corresponding an access link beam (or an (actual) physical beam) and/or a beam index not corresponding a beam (or an (actual) physical beam).

In some embodiments, a beam index range is predefined and/or is configured/indicated by higher-layer signaling. For example, all beam indices within the beam index range are predefined or are configured/indicated by the higher-layer signaling, or some beam indices therein are predefined while others are configured/indicated by the higher-layer signaling. For the latter case, for example, beam indices corresponding beams are predefined, while beam indices not corresponding to beams are configured/indicated by the higher-layer signaling; however, it is not limited thereto.

In some embodiments, one fifth information field is used to indicate one time domain resource index, or indicate at most one time domain resource index, or indicate multiple time domain resource indices. The index may be replaced with a sequence number.

In some embodiments, the fifth information field corresponds to a time domain resource table. The time domain resource table is predefined and/or is configured by the above first RRC message or other RRC messages. The time domain resource table includes one or more time domain resource configurations, and the time domain resource (TDRA) table (or simply referred to as a TDRA table) includes at least one row (column). For ease of description, one row (column) is hereinafter referred to as one TDRA configuration, and one TDRA configuration includes one or more time domain resources or does not include a time domain resource. A time domain resource is continuous or discontinuous.

In some embodiments, a time domain resource is, for example, defined by one or more of the following parameters: a slot offset K₃, a symbol offset S, a duration L used to determine a time domain resource, and a subcarrier spacing. These parameters are respectively predefined and/or are configured by higher-layer signaling, wherein, slot offset K₃ refers to an offset between a starting slot of a time domain resource or a first slot corresponding to/overlapping with/associated with the starting slot of the time domain resource and a reference point. The reference point may be determined at least based on a slot or symbol where the DCI carrying the second beam indication information is located, or a slot or symbol where a PUCCH/PUSCH of HARQ feedback of the DCI or PDCCH carrying the second beam indication information is located. If one time domain resource configuration includes multiple time domain resources, reference points of slot offsets of different time domain resources are identical (for example, all of them are determined at least based on the slot or symbol where the DCI of the second beam indication information is located) or different (for example, for a first one of time domain resource, they are determined at least based on the slot or symbol where the DCI of the second beam indication information is located, and, and for subsequent time domain resources, they are determined at least based on a slot or symbol where a previous time domain resource is located). The symbol offset S refers to an offset between a first symbol of a time domain resource and a boundary of the above starting slot/starting symbol/first symbol or a starting symbol/first symbol relative to the DCI or PDCCH/PDCCH MO carrying the second beam indication information. The duration L of the time domain resource, for example, denotes the number of symbols contained in the time domain resource. The symbol offset S and/or the duration L of the time domain resource must ensure that the configured time domain resource is within the same slot, or that the configured time domain resource may be within the same slot or may be across slots. Numbers of time domain resources included the configurations in the time domain resource table are identical or different.

In some embodiments, time domain resources in a configuration may be defined in a form of a list or sequence. For example, an IE is introduced, which includes parameters of the time domain resource defined above. A configuration includes a list or sequence, the list or sequence including one or more fields corresponding to the above IE.

In some embodiments, the fifth information field may indicate one or more time domain resources or may not indicate a time domain resource by indicating the configurations in the time domain resource table.

In some embodiments, the time domain resource index may include a time domain resource index corresponding to a time domain resource and/or a time domain resource index not corresponding to a time domain resource. For example, the time domain resource index is an index or sequence number configured by a column (row) in the time domain resource table to which the fifth information field corresponds. If all configurations in the time domain resource table include time domain resources, the time domain resource index includes only a time domain resource index corresponding to a time domain resource, and if there exist configurations that include time domain resources and configurations that do not include time domain resources in the time domain resource table, the time domain resource index includes a time domain resource index corresponding to a time domain resource and a time domain resource index not corresponding to a time domain resource. For another example, all configurations in the time domain resource list include time domain resources, if all values in the time domain resource indices correspond to the configurations in the time domain resource table, the time domain resource index includes only a time domain resource index corresponding to a time domain resource, and if a part of values in the time domain resource indices correspond to the configurations in the time domain resource table and another part of values do not correspond to any configuration in the time domain resource table, the time domain resource indices includes a time domain resource index corresponding to a time domain resource and a time domain resource index not corresponding to a time domain resource, wherein, the time domain resource index not corresponding to a time domain resource, for example, is predefined and/or is configured by higher-layer signaling.

How to determine/indicate the second beam shall be described below. For example, the second beam is a backhaul link beam, which refers to a beam used by a backhaul link when the forwarding entity of the repeater performs forwarding or a beam used by the network device side of the repeater. That is, the forwarding entity of the repeater uses the first beam to forward signals to the network device, or forwards signals from the network device side (that is, for the backhaul link or for forwarding), and/or, the second beam is a control link beam (that is, for a control link or for communication/information exchange between the NCR/NCR-MT and the network device). For example, the second beam includes a downlink beam (or a receiving beam, which is used to receive downlink signals and/or channels (transmitted to the NCR/NCR-MT and/or to be forwarded by the NCR/NCR-Fwd) from the network device and/or an uplink beam (or a transmitting beam, which is used to transmit uplink signals and/or channels (of the NCR/NCR-MT and/or from the UE/(forwarded (by the NCR/NCR-Fwd) to the network device)).

In some embodiments, the second beam may be determined according to the first indication information and/or a predefined rule.

In some embodiments, the second beam includes a (downlink) beam determined by a QCL assumption of a CORESET with a smallest ID and/or an (uplink) beam determined by a spatial relationship (in a CORESET configured for the first serving cell) of a PUCCH with a smallest (PUCCH resource) ID. For example, for the beam determined by a QCL assumption of a CORESET with a smallest ID, the CORESET with the smallest ID is a CORESET with an ID at a first DL BWP and/or a first time position. The CORESET may be CORESET #0, and the first DL BWP is at the Pcell, and/or, the first DL BWP is an initial DL BWP or a default DL BWP or an active DL BWP (or a DL BWP that initiates/performs beam failure recovery/corresponding random access procedure), and the first time position includes: the latest slot in which one or more CORESETs are monitored by the NCR-MT (such as within the active BWP of the serving cell (e.g. the Pcell)/within the above first DL BWP), or the latest/last slot in which (one or more) CORESETs are monitored by the NCR-MT. For example, for the beam determined by the spatial relationship of PUCCHs with the smallest PUCCH resource ID, the PUCCHs with the smallest PUCCH resource ID are PUCCHs with a lowest PUCCH resource ID at the first UL BWP and/or a second time position. The first UL BWP is at the Pcell, and/or, the first UL BWP is an initial UL BWP or a default UL BWP or an active UL BWP (or a UL BWP initiating/performing beam failure recovery/corresponding to a random access procedure), and the second time position includes: the latest slot in which PUCCH is transmitted by the NCR-MT (such as within the active BWP of the serving cell, or, the latest/last slot in which PUCCH is transmitted by the NCR-MT).

In some embodiments, the second beam includes: (a downlink and/or uplink beam determined) (by) an indicated unified TCI.

For example, when the Rel-15/16 beam indication framework is used for the control link, a (downlink) beam determined by the QCL assumption of the CORESET with the smallest ID and/or an (uplink) beam determined by the spatial relationship of the PUCCH with the smallest (PUCCH resource) ID (in the CORESET configured for the first serving cell); and when the Rel-17 beam indication framework (i.e. a unified TCI framework) is used for the control link, (a downlink and/or uplink beam determined) (by) an indicated unified TCI.

In some embodiments, the second beam is indicated by the second indication information. The second beam may be determined according to the second indication information, such as determining the second beam according to the first information field in the second indication information, which shall not be repeated herein any further.

In some embodiments, the method further includes:
in case of beam failure, the NCR-MT does not monitoring or does not receiving the first DCI (format) and/or the second DCI. Description of the first DCI and the second DCI is as described above, which shall not be repeated herein any further.

In some embodiments, during the beam failure recovery procedure (or until the BFR is successful, or before the BFR is successful), the NCR-MT does not monitor the first DCI (format).

In some embodiments, after the BFR is successful, the NCR-MT monitors the first DCI (format), such as monitoring the first DCI format by using the first beam.

In some embodiments, the NCR-MT does not monitor the first DCI (format), until the first indication information (control link beam indication/configuration) and/or the second indication information (or backhaul link beam configuration/indication) and/or the third indication information (or access link beam configuration/indication) is/are received, and/or the first indication information and/or the second indication information and/or the third indication information is/are applied (or beam(s) indicated by the above indication information is/are applied) (or, therebefore).

In some embodiments, after receiving the first indication information (control link beam indication/configuration) and/or the second indication information (or backhaul link beam configuration/indication) and/or the third indication information (or access link beam configuration/indication), and/or applying the first indication information and/or the second indication information and/or the third indication information (or applying the beam(s) indicated by the above indication information), the NCR-MT monitors the first DCI (format).

In some embodiments, (before beam failure) the NCR/NCR-MT (is configured/indicated to) monitors the first DCI in the above SS (first SS) (the search space provided by recovery SearchSpaceId) or the second SS (another SS). A CORESET with which the second SS is associated is identical to or different from a CORESET with which the first SS is associated.

In some embodiments, after the BF, the NCR/NCR-MT does not monitor the first DCI. After the BFR is successful, the NCR-MT monitors the first DCI (format) (by using the first beam). The NCR-MT does not monitor the first DCI (format), until the first indication information (control link beam indication/configuration) and/or the second indication information (or backhaul link beam configuration/indication) and/or the third indication information (or access link beam configuration/indication) is/are received and/or the first indication information and/or the second indication information and/or the third indication information is/are applied (or the beam(s) indicated by the above indication information is/are applied) (or therebefore). After receiving the first indication information (control link beam indication/configuration) and/or the second indication information (or backhaul link beam configuration/indication) and/or the third indication information (or access link beam configuration/indication) and/or applying the first indication information and/or the second indication information and/or the third indication information (or applying the beam(s) indicated by the above indication information), the NCR-MT monitors the first DCI (format). Reference may be made to the above embodiments for how to monitor the DCI/PDCCH.

In some embodiments, the method further includes:
the NCR-MT monitors the first DCI (format) in case of beam failure, the first DCI being used to indicate the access link beam. Description of the first DCI is as described above, which shall not be repeated herein any further. For example, after the BF, the NCR/NCR-MT monitors the first DCI (in the first SS/second SS), and when/after the first DCI is received, the random access procedure is (successfully) completed and/or the beam failure recovery is (successfully) completed, wherein, the PDCCH to which the first DCI corresponds is one of the above first PDCCHs, which may be scrambled by using the RNTI for the NCR.

In some embodiments, during the beam failure recovery process (or until the BFR is successful, or before the BFR is successful), the NCR-MT monitors the first DCI (format).

In some embodiments, the NCR-MT monitors the first DCI before the beam failure and/or the beam failure recovery.

It can be seen from the above embodiment that after detecting the beam failure, the NCR may not perform forwarding, thereby enabling the time domain resources/beams corresponding to the ON state of the forwarding entity to match with the time domain resources/beams of the data transmission between the network device and the terminal equipment, saving power consumption of the repeater, reducing interference, and improving network throughput.

The embodiments of this disclosure provide a forwarding control method, which shall be described from a repeater side, with parts repeated with those in the above embodiments being not going to be described herein any further.

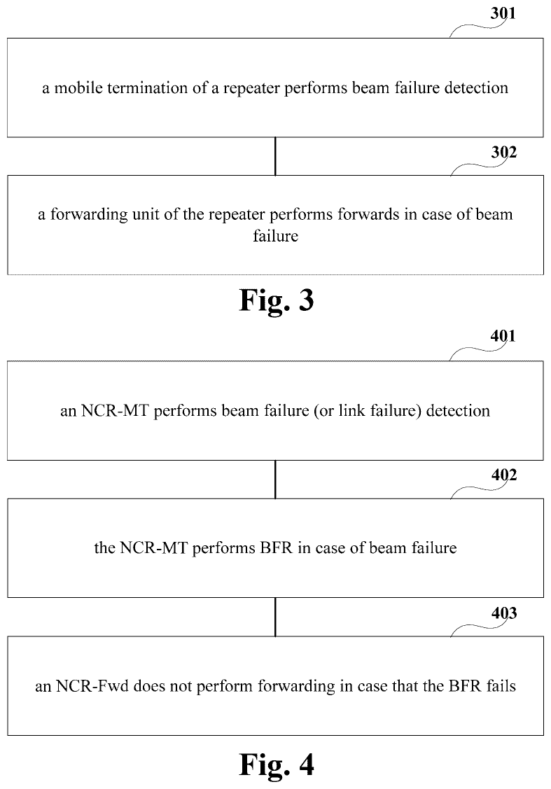

FIG. 3 is a schematic diagram of the forwarding control method of the embodiments of this disclosure. As shown in FIG. 3, the method includes:

301: a mobile termination of a repeater performs beam failure detection; and

302: a forwarding entity of the repeater performs forwarding in case of beam failure.

It should be noted that FIG. 3 only schematically illustrates the embodiments of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 3.

In some embodiments, reference may be made to 201 for implementation of 301, which shall not be repeated herein any further. The method may further include: the repeater (NCR/NCR-MT) performs beam failure recovery (BFR), wherein reference may be made to the above embodiments for implementation thereof, which shall not be repeated herein any further.

In some embodiments, in case of beam failure, the forwarding entity of the repeater (is expected/allowed to) performs forwarding (or may (or may be allowed) turn on/perform forwarding), such as performing forwarding by using a third beam. The third beam is a backhaul link beam, which is indicated and/or determined before the beam failure. In other words, in case of beam failure in the first cell, the repeater performs forwarding by using the backhaul link beam before the beam failure.

For example, the backhaul link beam before beam failure includes:
when the Rel-15/16 beam indication framework is used for the control link, a backhaul link may be determined according to predetermined rule 1, such as a (downlink) beam determined by the QCL assumption of the CORESET with the smallest ID and/or an (uplink) beam determined by the spatial relationship of the PUCCH with the smallest (PUCCH resource) ID (in the CORESET configured for the first serving cell); or, the backhaul link beam may be indicated by indication information, and reference may be made to the second indication information for implementation of the indication information, which shall not be repeated herein any further.

When the Rel-17 beam indication framework (i.e. a unified TCI framework) is used for the control link, the backhaul link may be determined according to predetermined rule 1, or the backhaul link may be determined according to predetermined rule 2, such as (a downlink and/or uplink beam determined by) an indicated unified TCI (such as being indicated by the first indication information). Or, the backhaul link beam may be indicated by indication information, and reference may be made to the second indication information for implementation of the indication information, which shall not be repeated herein any further.

In addition, it should be noted that the access link beam (the fourth beam) before the beam failure may be configured by RRC signaling and/or indicated by active access link beam indication activation signaling, or may be indicated by DCI (such as the first DCI) only.

In some embodiments, the NCR-Fwd performs forwarding by using the third beam, until the BFR is successful (or before the BFR is successful). That is, during the beam failure recovery (random access procedure), the NCR-Fwd performs forwarding by using the third beam, until the BFR is successful. For example, after the BFR is successful, the NCR-Fwd performs forwarding by using the third beam. Or, for example, after a first time period after the first PDCCH, the NCR-Fwd performs forwarding by using the third beam. The first PDCCH and the first time period are as described above, which shall not be repeated herein any further.

As described above, the NCR-Fwd performs forwarding by using the third beam after the BFR is successful, or after the first time period after the first PDCCH, until the first indication information (control link beam indication/configuration) and/or the second indication information (or backhaul link beam configuration/indication) and/or the third indication information (or access link beam configuration/indication) is/are received and/or the first indication information and/or the second indication information and/or the third indication information is/are applied (or the beam(s) indicated by the above indication information is/are applied), or, the NCR-Fwd performs forwarding by using the third beam after the BFR is successful, or after the first time period after the first PDCCH and before the first indication information (control link beam indication/configuration) and/or the second indication information (or backhaul link beam configuration/indication) and/or the third indication information (or access link beam configuration/indication) is/are received and/or before the first indication information and/or the second indication information and/or the third indication information is/are applied (or the beam(s) indicated by the above indication information is/are applied). And the NCR-Fwd performs forwarding by using the second beam after the first indication information (control link beam indication/configuration) and/or the second indication information (or backhaul link beam configuration/indication) and/or the third indication information (or access link beam configuration/indication) is/are received and/or the first indication information and/or the second indication information and/or the third indication information is/are applied (or the beam(s) indicated by the above indication information is/are applied). The above indication information and second beam are as described in the above embodiment, which shall not be repeated herein any further.

In some embodiments, the NCR-Fwd performs forwarding by using the second beam after the first indication information (control link beam indication/configuration) and/or the second indication information (or backhaul link beam configuration/indication) and/or the third indication information (or access link beam configuration/indication) is/are received and/or the first indication information and/or the second indication information and/or the third indication information is/are applied (or the beam(s) indicated by the above indication information is/are applied) (or the beam(s) indicated by the above indication information is/are applied). In addition, when there is no indication from the first indication information and the second indication information, but the third indication information indicates that the NCR may perform forwarding, the NCR performs forwarding by using the predefined first beam, or still by using the third beam.

In some embodiments, the method further includes:
the NCR-MT does not monitor or does not receive the first DCI (format) and/or the second DCI in case of beam failure. Description of the first DCI and the second DCI is as described above, which shall not be repeated herein any further.

In some embodiments, during the beam failure recovery process (or until the BFR is successful, or before the BFR is successful), the NCR-MT does not monitor the first DCI (format).

In some embodiments, after the BFR is successful, the NCR-MT monitors the first DCI (format), such as monitoring the first DCI format by using the first beam.

In some embodiments, the NCR-MT does not monitor the first DCI (format) until (or before) the first indication information (control link beam indication/configuration) and/or the second indication information (or backhaul link beam configuration/indication) and/or the third indication information (or access link beam configuration/indication) is/are received and/or the first indication information and/or the second indication information and/or the third indication information is/are applied (or the beam(s) indicated by the above indication information is/are applied).

In some embodiments, the NCR-MT monitors the first DCI (format) after the first indication information (control link beam indication/configuration) and/or the second indication information (or backhaul link beam configuration/indication) and/or the third indication information (or access link beam configuration/indication) is/are received and/or the first indication information and/or the second indication information and/or the third indication information is/are applied (or the beam(s) indicated by the above indication information is/are applied).

In some embodiments, the method further includes:
the NCR-MT monitors the first DCI (format) in case of beam failure, the first DCI being used to indicate an access link beam. Description of the first DCI is as described above, which shall not be repeated herein any further.

In some embodiments, during the beam failure recovery process (or until the BFR is successful, or before the BFR is successful), the NCR-MT monitors the first DCI (format).

In some embodiments, the NCR-MT monitors the first DCI before the beam failure and/or the beam failure recovery.

It can be seen from the above embodiments that after the beam failure is detected, the NCR may perform forwarding, thereby enabling the time domain resources/beams corresponding to the ON state of the forwarding entity to match with the time domain resources/beams of the data transmission between the network device and the terminal equipment, saving power consumption of the repeater, reducing interference, and improving network throughput.

In the embodiments of FIG. 2 above, in case of beam failure, the forwarding entity of the repeater is turned off/does not perform forwarding. In the embodiments of FIG. 3, in case of beam failure, the forwarding entity of the repeater performs forwarding. However, the embodiments of this disclosure are not limited thereto, for example, in case of beam failure, based on NCR implementation, the forwarding entity of the repeater is turned off/does not perform or performs forwarding, which shall not be enumerated herein any further.

The embodiments of this disclosure provide a forwarding control method, which shall be described from a repeater side, with parts repeated with those in the above embodiments being not going to be described herein any further.

FIG. 4 is a schematic diagram of the forwarding control method of the embodiments of this disclosure. As shown in FIG. 4, the method includes:

401: an NCR-MT performs beam failure (or link failure) detection;

402: the NCR-MT performs BFR in case of beam failure; and

403: an NCR-Fwd does not perform forwarding in case that the BFR fails.

Implementations of 401-402 are as described in the above embodiments, and shall not be repeated herein any further. Processing of the NCR-Fwd after the BFR is successful is described in the above embodiments. In 403, in the case where the BFR fails, or when there exists an issue of random access, the NCR-Fwd does not perform forwarding, wherein after the BFR fails, if the random access procedure fails, the NCR deems that a radio link failure (RLF) occurs.

It can be seen from the above embodiments that after the BFR fails, the NCR does not perform forwarding, thereby enabling the time domain resources/beams corresponding to the ON state of the forwarding entity to match with the time domain resources/beams of the data transmission between the network device and the terminal equipment, saving power consumption of the repeater, reducing interference, and improving network throughput.

Furthermore, it was found by the inventors that a prerequisite for the NCR-Fwd to be able to forward signals in a period of time includes that: for the period of time, the NCR has not only an access link beam, but also an applicable backhaul link beam. At present, it has been agreed in the standards that the on state “ON” of the NCR-Fwd is indicated implicitly by an access link beam indication. That is, on a time domain resource (time period) of the indicated access link beam, the NCR-Fwd is in the on state and should forward signals. However, according to current progress, it is possible that the NCR receives an access link beam indication before any applicable backhaul link beam exists; however, there is no corresponding method for how the NCR handles such a case.

Addressed to the above problem, the embodiments of this disclosure provides a forwarding control method, which shall be described from a repeater side, with parts repeated with those in the above embodiments being not going to be described herein any further.

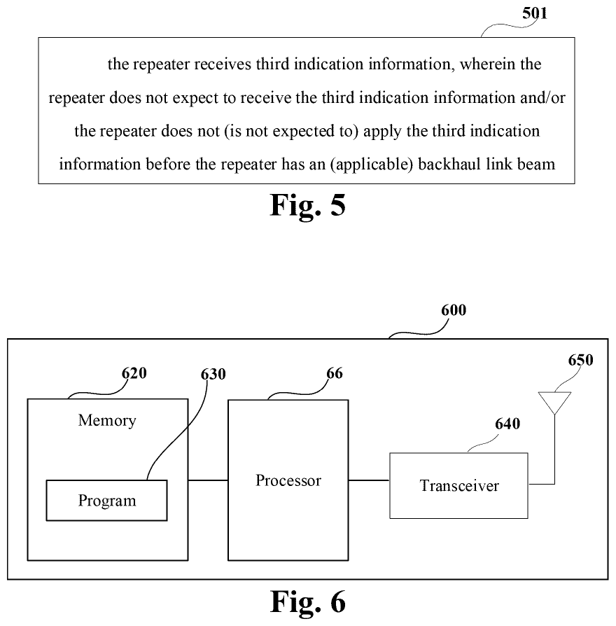

FIG. 5 is a schematic diagram of the forwarding control method of the embodiments of this disclosure. As shown in FIG. 5, the method includes:

501: the repeater receives third indication information,
wherein the repeater does not expect to receive the third indication information and/or the repeater does not (is not expected to) apply the third indication information before the repeater has an (applicable) backhaul link beam.

In some embodiments, before the repeater has an (applicable) backhaul link beam, the method includes:
before determining the backhaul link beam (or receiving first indication information) (according to a predefined rule and/or first indication information), and/or,
before applying the determined backhaul link beam (according to predefined rule and/or the first indication information), and/or
before being configured with/indicated a backhaul link beam (or receiving second indication information), and/or
before applying the indicated backhaul link beam (or applying second indication information).

Reference may be made to the above embodiments for the indication information, which shall not be repeated herein any further.

The embodiments of this disclosure provide a forwarding control method, which shall be described from a repeater side, with parts repeated with those in the above embodiments being not going to be described herein any further.

FIG. 14 is a schematic diagram of the forwarding control method of the embodiments of this disclosure. As shown in FIG. 14, the method includes:

1401: a mobile termination of the repeater performs beam failure detection; and

1402: the mobile termination of the repeater monitors or does not monitor first DCI (format) and/or second DCI in case of beam failure, the first DCI being used to indicate an access link beam, and the second DCI being used to indicate a unified TCI (state).

Reference may be made to the above embodiments for implementations of 1401-1402, which shall not be repeated herein any further.

Implementations of the above forwarding control methods are as described above, and shall not be enumerated herein any further. The above implementations only illustrate the embodiments of this disclosure. However, this disclosure is not limited thereto, and appropriate variants may be made on the basis of these implementations. For example, the above implementations may be executed separately, or one or more of them may be executed in a combined manner. For example, the NCR may perform BFD, and before the BF, the repeater may perform forwarding by using the above third beam (and/or fourth beam). After the BF, the NCR-Fwd may forward signals (by using the third beam forwarding) or may not forward signals according to the embodiments in FIG. 2 or FIG. 3, and the NCR-MT initiates the BFR. After the BFR fails, the NCR-Fwd does not forward according to the embodiments in FIG. 4, and after the BFR is successful or after a new configuration is received, the NCR-Fwd performs forwarding by using the second beam.

In the above embodiments, the BFD/BFR in case of single TRP is mainly described; however, the embodiments of this disclosure is not limited thereto, for example, it is also applicable in case of multi-TRP.

In some embodiments, the NCR/NCR-MT does not support (is not expected to be configured with) multi-TRP operations or BFD or two groups of BFD reference signals in multi-TRP operations.

In some embodiments, NCR/NCR-MT is configured with multi-TRP operations or BFD or two groups of BFD reference signals in multi-TRP operations. In this case, for beam failure detection in the multi-TRP operations, the network device configures two groups (sets) of BFD reference signals for the NCR. Before a configured timer expires, when the number of BFIs from a physical layer related to a group corresponding to the BFD reference signals reaches a configured threshold, the NCR deems that a beam failure occurs in a TRP/BFD reference signal group.

After a beam failure is detected for the BFD-RS set of the serving cell (the first cell), the NCR triggers beam failure recovery by initiating transmission of BFR MAC CEs for the BFD-RS set, selects a suitable beam (if available) for the BFD-RS set, and indicates whether the suitable (new) beam is found or not along with the information about the beam failure in the BFR MAC CE for this BFD-RS set.

Once the PDCCH is received, the PDCCH indicates an uplink grant for new transmission of an HARQ process, the HARQ process being used for the transmission of the BFR MAC CEs of the BFD-RS set, and it is deemed that beam failure recovery of the BFD-RS set is completed.

After beam failures are detected simultaneously in the two BFD-RS sets of the PCell, the NCR triggers beam failure recovery by initiating a random access procedure on the PCell, selects an appropriate beam (if any) for each failed BFD-RS, and indicates whether a suitable (new) beam is found and not along with the information about the beam failure in the BFR MAC CEs for each failed BFD-RS set. After the random access procedure is completed, beam failure recovery of the two BFD-RS sets of the PCell is deemed as being completed.

### Embodiments of a Second Aspect

The embodiments of this disclosure provide a repeater. The repeater may be, for example, the NCR as described above, or a network device or terminal equipment having a function of forwarding, or one or some components or assemblies configured in the NCR or the network device or the terminal equipment.

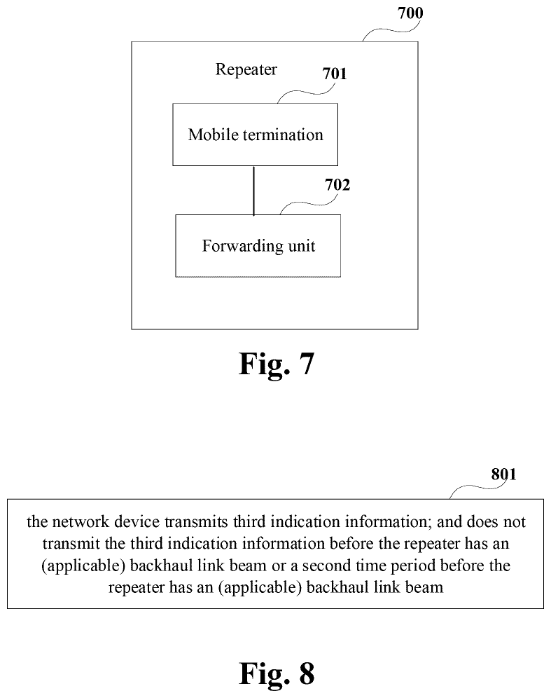

FIG. 7 is a schematic diagram of the repeater of the embodiments of this disclosure. As a principle of the repeater for solving problems is similar to that of the method in the embodiment of the first aspect, reference may be made to the implementation of the method described in the embodiment of the first aspect for implementation of the repeater, with identical or related contents being not going to be described herein any further.

As shown in FIG. 7, a repeater 700 in the embodiment of this disclosure includes: a mobile termination 701 and a forwarding entity 702, the mobile termination 701 and the forwarding entity 702 being functional entities, and their functions being implemented by different hardware modules.

The mobile termination 701 performs beam failure detection,
and the forwarding entity 702 is turned off/does not perform forwarding or performs forwarding in case of beam failure.
Or,
the mobile termination 701 performs beam failure (or link failure) detection, and the mobile termination 701 performs BFR in case of beam failure,
and the forwarding entity 702 does not perform forwarding in case of beam failure.
Or,
the mobile termination 701 receives third indication information, and the repeater does not expect to receive the third indication information and/or the repeater does not (is not expected to) apply the third indication information before the repeater has an (applicable) backhaul link beam.
Or,
the mobile termination 701 performs beam failure (or link failure) detection, and the mobile termination of the repeater monitors or does not monitor first DCI and/or second DCI in case of beam failure, the first DCI being used to indicate an access link beam, and the second DCI being used to indicate a unified TCI (state).

Reference may be made to the embodiment of the first aspect for implementations of the mobile termination 701 and the forwarding entity 702, which shall not be repeated herein any further.

Furthermore, for the sake of simplicity, connection relationships between the components or modules or signal profiles thereof are only illustrated in FIG. 7. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Third Aspect

The embodiments of this disclosure provide an information transmission method, which shall be described from a network device side, with parts repeated with those in the embodiment of the first aspect being not going to be described herein any further.

FIG. 8 is a schematic diagram of the information transmission method of the embodiments of this disclosure. As shown in FIG. 8, the method includes:

801: the network device transmits third indication information; and does not transmit the third indication information before the repeater has an (applicable) backhaul link beam or a second time period before the repeater has an (applicable) backhaul link beam.

In some embodiments, the second time period includes a time needed by the repeater in applying the third indication information.

Reference may be made to the embodiments of the first aspect for the third indication information, which shall not be repeated herein any further.

Or, the method includes (not shown):
the network device transmits first indication information and/or second indication information and/or third indication information to the NCR (a third time period) after beam failure recovery of the NCR is successful, the first indication information being used to indicate/configure a control link beam, the second indication information being used to indicate a backhaul link beam, and the third indication information being used to indicate an access link beam. For example, the third time period may be greater than or equal to the above first time period; however, this embodiments of this disclosure are not limited thereto.

It should be noted that FIG. 8 only schematically illustrates the embodiments of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 8.

The steps or processes related to this disclosure are only described above; however, this disclosure is not limited thereto. The method of the embodiments of this disclosure may also include other steps or processes, and reference may be made to relevant techniques for specific contents of these steps or processes.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fourth Aspect

The embodiments of this disclosure provide a network device.

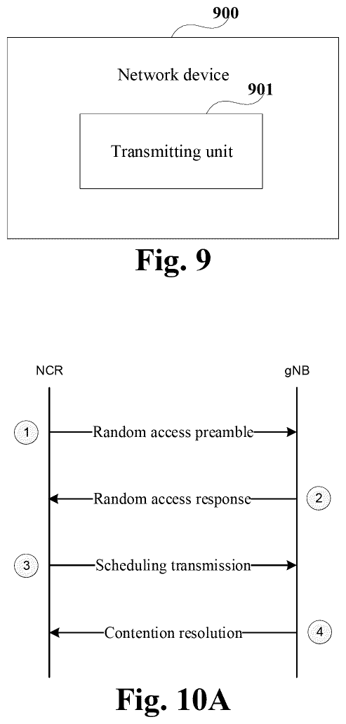

FIG. 9 is a schematic diagram of the network device of the embodiments of this disclosure. As a principle of the network device for solving problems is similar to that of the method in the embodiment of the third aspect, reference may be made to the embodiments of the third aspect for implementation of the network device, with identical or related contents being not going to be described herein any further.

As shown in FIG. 9, a network device 900 of the embodiments of this disclosure includes:
a transmitting unit 901 configured to transmit third indication information, wherein the third indication information is not transmitted before a repeater has an (applicable) backhaul link beam or a second time period before the repeater has an (applicable) backhaul link beam, or,
a transmitting unit 901 configured to transmit first indication information and/or second indication information and/or third indication information to an NCR (a third time period) after beam failure recovery of the NCR is successful, the first indication information being used to indicate/configure a control link beam, the second indication information being used to indicate a backhaul link beam, and the third indication information being used to indicate an access link beam.

Reference may be made to the embodiments of the third aspect for implementations of the transmitting unit 901 and the information, which shall not be repeated herein any further.

It should be noted that the components or modules related to this disclosure are only described above. However, this disclosure is not limited thereto, and the network device 900 of the embodiment of this disclosure may further include other components or modules, and reference may be made to related techniques for particulars of these components or modules.

Furthermore, for the sake of simplicity, connection relationships between the components or modules or signal profiles thereof are only illustrated in FIG. 9. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

### Embodiments of a Fifth Aspect

The embodiments of this disclosure provide a communication system. FIG. 1 is a schematic diagram of the communication system of the embodiment of this disclosure. As shown in FIG. 1, a communication system 100 includes a network device 101, a repeater 102 and a terminal equipment 103. For the sake of simplicity, description is given in FIG. 1 by taking one network device, one repeater and one terminal equipment only as an example; however, the embodiments of this disclosure are not limited thereto.

In the embodiments of this disclosure, existing traffics or traffics that may be implemented in the future may be performed between the network device 101 and the terminal equipment 103. For example, such traffics may include but not limited to enhanced mobile broadband (eMBB), massive machine type communication (mMTC), ultra-reliable and low-latency communication (URLLC), and vehicle to everything (V2X) communication, etc. The repeater 102 is configured to execute the forwarding control method in the embodiment of the first aspect, and the network device 101 is configured to execute the information transmission method in the embodiment of the third aspect, contents of which being incorporated herein, which shall not be repeated herein any further.

The embodiments of this disclosure further provide an electronic device, which may be, for example, a repeater or a network device.

FIG. 6 is a schematic diagram of a structure of the electronic device of the embodiment of this disclosure. As shown in FIG. 6, an electronic device 600 may include a processor 66 (such as a central processing unit (CPU)) and a memory 620, the memory 620 being coupled to the processor 66. The memory 620 may store various data, and furthermore, it may store a program 630 for information processing, and execute the program 630 under control of the processor 66.

For example, the processor 66 may be configured to execute a program to execute the forwarding control method described in the embodiments of the first aspect.

For another example, the processor 66 may be configured to execute a program to execute the information transmission method described in the embodiments of the third aspect.

Furthermore, as shown in FIG. 6, the electronic device 600 may include a transceiver 640, and an antenna 650, etc. Functions of the above components are similar to those in the related art, and shall not be described herein any further. It should be noted that the electronic device 600 does not necessarily include all the parts shown in FIG. 6, and furthermore, the electronic device 600 may include parts not shown in FIG. 6, and the related art may be referred to.

Embodiments of this disclosure provide a computer readable program, which, when executed in a repeater, will cause a computer to carry out the forwarding control method described in the embodiments of the first aspect in the repeater.

Embodiments of this disclosure provide a storage medium, including a computer readable program, which will cause a computer to carry out the forwarding control method as described in the embodiments of the first aspect in a repeater.

Embodiments of this disclosure provide a computer readable program, which, when executed in a network device, will cause a computer to carry out the information transmission method described in the embodiments of the third aspect in the network device. Embodiments of this disclosure provide a storage medium, including a computer readable program, which will cause a computer to carry out the information transmission method as described in the embodiments of the third aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile termination, and may also be stored in a memory card of a pluggable mobile termination. For example, if equipment (such as a mobile termination) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

The embodiments of this disclosure include the following supplements.
1. A forwarding control method, applicable to a repeater, characterized in that the method includes:
performing beam failure detection by a mobile termination of the repeater (for a first cell); and
(expected) turning off a forwarding entity of the repeater/not forwarding by the forwarding entity of the repeater (or, not allowing the forwarding entity to be turned on/to forward) in case of beam failure (on the first cell) (in a case where the repeater detects a beam failure).
2. The method according to supplement 1, wherein the first cell is a primary cell (Pcell), or a PScell, or an Scell.
3. The method according to supplement 1 or 2, wherein the method further includes:
performing beam failure recovery (BFR) (for the first cell) by the repeater (NCR/NCR-MT).
4. The method according to supplement 3, the beam failure recovery includes: performing random access (on the first cell), or transmitting an SR and/or an MAC CE for BFR (to a second cell).
5. The method according to any one of supplements 1-4, wherein the method further includes:
(expected) turning off the NCR-Fwd/not forwarding by the NCR-Fwd (or, not allowing the NCR-Fwd to be turned on/to forward), until the BFR is successful (or before the BFR is successful).
6. The method according to any one of supplements 1-5, wherein the method further includes:
performing forwarding by the repeater (by using a first beam) after the BFR is successful (until first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied) (or therebefore).
7. The method according to any one of supplements 1-5, wherein the method further includes:
performing forwarding at the NCR-Fwd (by using a first beam) after a first time period (such as after 28 symbols from a last symbol of a first PDCCH reception in a search space set provided by recovery SearchSpaceId for which the UE detects a DCI format with CRC scrambled by C-RNTI or MCS-C-RNTI) (until first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied) (or therebefore).
8. The method according to supplement 7, wherein the first PDCCH is used to determine that the beam failure recovery is successful and/or to determine that a random access procedure is completed.
9. The method according to any one of supplements 6-8, wherein the first beam is identical to beams (including beams determined (according to) by SSBs associated with an RO (RACH occasion) of/used by last PRACH transmission) used in a (last) random access attempt/procedure (or a successful random access attempt/procedure) (in the beam failure recovery, or used for the beam failure recovery, or initiated for the beam failure recovery).
10. The method according to any one of supplements 6-9, wherein the first beam includes a downlink beam (or a receive beam for receiving downlink signals and/or channels from a network device (transmitted to an NCR/NCR-MT and/or to be forwarded by an NCR/NCR-FWd) and/or an uplink beam (or a transmit beam for transmitting uplink signals and/or channels (of the NCR/NCR-MT and/or from the UE/(by the NCR/NCR-MT) forwarded to the network device) to the network device).
11. The method according to any one of supplements 6-10, wherein the first beam includes: same antenna port quasi-collocation parameters as the ones associated with index q_{new} (or (downlink) beams determined by the QCL parameters) and/or a same spatial filter as for the last PRACH transmission (or (uplink) beams determined by the spatial filter), and/or, (downlink and/or uplink) beams determined by the SSBs associated with the RO (RACH occasion) of (used by) the last PRACH transmission, and/or, downlink beams for receiving the first PDCCH, and/or uplink beams for transmitting the last PRACH (transmission).
12. The method according to any one of supplements 6-11, wherein the first beam is used for forwarding when NCR-MT/C-link has or does not have reception or transmission.
13. The method according to any one of supplements 6-12, wherein the first beam is predefined (such as being specified in a protocol or being determined according to a predefined rule) or is indicated.
14. The method according to any one of supplements 6-13, the first beam is a backhaul link beam (that is, it is used for a backhaul link or for forwarding) and/or a control link beam (that is, it is used for a control link or for communication/information exchange between the repeater and the network device).
15. The method according to any one of supplements 1-5, wherein the method further includes:
(expected) turning off the NCR-Fwd/not forwarding by the NCR-Fwd (or, not allowing the NCR-Fwd to be turned on/to forward) before the beam failure recovery is successful, until first indication information (control link beam indication/configuration) and/or second indication information (or backhaul link beam configuration/indication) and/or third indication information (or access link beam configuration/indication) is/are received, and/or first indication information and/or second indication information and/or the third indication information is/are applied (or beams indicated by the above indication information are applied) (or therebefore).
16. The method according to any one of supplements 1-15, wherein the method further includes:
performing forwarding by the repeater (by using a second beam) after receiving first indication information (control link beam indication/configuration) and/or second indication information (or backhaul link beam configuration/indication) and/or third indication information (or access link beam configuration/indication) and/or applying first indication information and/or second indication information and/or third indication information (or beams indicated by the above indication information) (or beams indicated by the above indication information).
16a. The method according to any one of supplements 1-16, wherein the repeater performs forwarding by using a first beam or a third beam after receiving first indication information (control link beam indication/configuration) and/or second indication information (or backhaul link beam configuration/indication) and/or third indication information (or access link beam configuration/indication) and/or applying first indication information and/or second indication information and/or third indication information (or beams indicated by the above indication information) (or beams indicated by the above indication information).
17. The method according to any one of supplements 5-16a, wherein that the beam failure recovery is successful includes:
that (for CFRA) the NCR-MT detects DCI (format) with CRC scrambled by a C-RNTI or an MCS-C-RNTI or an RNTI for NCR in a search space (SS) provided by recoverySearchSpaceId (or receives a PDCCH transmission at the SS, the PDCCH transmission being addressed to the C-RNTI or the MCS-C-RNTI or the RNTI for NCR), and/or, receives a first PDCCH (the first PDCCH being addressed to the C-RNTI or the MCS-C-RNTI or the RNTI for NCR; for example, in the CFRA, the first PDCCH (NCR/NCR-MT) is after transmitting MsgA or PRACH, it is received during an RAR window), and/or, (during the beam failure recovery, or for the beam failure recovery, or initialized for the beam failure recovery), the (contention-free) random access procedure is (successfully) completed, and/or the beam failure recovery is (successfully) completed; or,
that (for CFRA) the NCR-MT detects DCI (format) with CRC scrambled by a C-RNTI or an MCS-C-RNTI or an RNTI for NCR in a search space (SS) provided by recovery SearchSpaceId (or receives a PDCCH transmission at the SS, the PDCCH transmission being addressed to the C-RNTI or the MCS-C-RNTI or the RNTI for NCR), and/or, receives a first PDCCH (the first PDCCH being addressed to the C-RNTI or the MCS-C-RNTI or the RNTI for NCR; for example, in 2-step CFRA, the first PDCCH is after transmitting MsgA (by NCR/NCR-MT), in 4-step CFRA, the first PDCCH is after transmitting Msg.3 (by NCR/NCR-MT), it is received during contention resolution window), and the contention resolution is successful, and/or, (during the beam failure recovery, or for the beam failure recovery, or initialized for the beam failure recovery), the (contention-based) random access procedure is (successfully) completed, and/or the beam failure recovery is (successfully) completed.
18. The method according to any one of supplements 6-17, wherein the first indication information is used to indicate/configure a control link beam (for configuring and/or activating a TCI state/SRI (SpatialRelationInfo) (for a PDSCH and/or a PDCCH and/or a PUCCH and/or an SRS), including RRC signaling, and/or an MAC CE, and/or DCI).
19. The method according to any one of supplements 6-18, wherein the first indication information includes:
an MAC CE activation command for a TCI state (or an activation for a TCI state) or tci-StatesPDCCH-ToAddList (−r17/r18) and/or tci-StatesPDCCH-ToReleaseList (−r17/r18) (of any parameter), and/or,
PUCCH resource(s) for PUCCH-SpatialRelationInfo (−r17/r18), and/or an (MAC CE) activation command for PUCCH-SpatialRelationInfo (−r17/r18), and/or,
tci-StatesToAddModLis (−r17/r18) and/or tci-StatesToReleaseList (−r17/r18) (configured for a PSDCH/in PDSCH-Config), and/or,
dl-OrJointTCI-StateList (−r17/r18) and/or dl-OrJointTCI-StateToAddModList (−r17/r18) and/or dl-OrJointTCI-StateToReleaseList (−r17/r18) (configured for a PSDCH/in PDSCH-Config), and/or,
ul-TCI-ToAddModList, and/or,
second DCI (such as DCI formats 1_1/1_2, etc.) (used to indicate (or having indicated) unified TCI).
20. The method according to any one of supplements 16-19, wherein the method further includes:
determining the second beam (including an uplink beam and/or a downlink beam) (according to the first indication information and/or the predefined rule) (or, the second beam is predefined (including being determined according to the first indication information and/or the predefined rule)).
21. The method according to any one of supplements 16-20, wherein the second beam includes:
a (downlink) beam determined by a QCL assumption of a CORESET with a minimum ID and/or an (uplink) beam determined by a spatial relationship of a PUCCH (in a CORESET configured for the first serving cell) with a minimum (PUCCH resource) ID; and/or,
(a downlink and/or an uplink beam determined by) an indicated unified TCI.
22. The method according to any one of supplements 6-17, wherein the second indication information is used to indicate a backhaul link beam (such as an MAC CE).
23. The method according to any one of supplements 16 or 16a or 22, wherein the second beam is indicated by the second indication information.
24. The method according to supplement 22, wherein the method further includes:
determining the second beam (according to the second indication information).
25. The method according to any one of supplements 6-17, wherein the third indication information is used to indicate an access link beam.
26. The method according to any one of supplements 6-17, wherein the third indication information includes: a periodic/semi-persistent access link beam indication (or provided by RRC signaling), an activation command (MAC CE/DCI) (for activating an access link beam indication), information for configuring/indicating (NCR/NCR-MT monitoring) first DCI, and first DCI (for indicating an access link beam).
27. The method according to any one of supplements 1-26, wherein the method further includes:
not monitoring (or not receiving) first DCI (format) and/or second DCI by the NCR-MT in case of beam failure, the first DCI being used to indicate an access link beam.
28. The method according to any one of supplements 1-27, wherein the NCR-MT does not monitor first DCI (format) during the beam failure recovery (or until or before the BFR is successful).
29. The method according to supplement 27 or 28, wherein after the BFR is successful, the NCR-MT monitors first DCI (format) (by using the first beam).
30. The method according to supplement 27 or 28, wherein the NCR-MT does not monitor the first DCI (format) until first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied) (or therebefore).
31. The method according to supplement 30, wherein the NCR-MT monitors first DCI (format) after first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied).
32. The method according to any one of supplements 1-26, wherein the method further includes:
monitoring first DCI (format) by the NCR-MT in a case of beam fails, the first DCI being used to indicate the access link beam.
33. The method according to any one of supplements 1-27, wherein the NCR-MT monitors first DCI (format) during the beam failure recovery (or until or before the BFR is successful).
34. The method according to any one of supplements 1-33, wherein the NCR-MT monitors first DCI when the beam fails and/or before the beam failure recovery.
35. A forwarding control method, applicable to a repeater, characterized in that the method includes:
performing beam failure (or link failure) detection by a mobile termination of the repeater (for a first cell); and
not monitoring (or not receiving) first DCI (format) and/or second DCI by the NCR-MT in case of beam failure, the first DCI being used to indicate an access link beam; or, monitoring first DCI (format) by the NCR-MT, the second DCI being used to indicate a unified TCI state.
36. A repeater, including a memory and a processor, the memory storing a computer program, and the processor being configured to execute the computer program to carry out the forwarding control method as described in any one of supplements 1-35.
37. An information transmission method, applicable to a network device, characterized in that the method includes:
transmitting first indication information and/or second indication information and/or third indication information by the network device to an NCR (a third first time period) after beam failure recovery of the NCR is successful,
the first indication information being used to indicate/configure a control link beam, the second indication information being used to indicate a backhaul link beam, and the third indication information being used to indicate an access link beam.
38. A network device, including a memory and a processor, the memory storing a computer program, and the processor being configured to execute the computer program to carry out the information transmission method as described in supplement 37.
1. A forwarding control method, applicable to a repeater, characterized in that the method includes:
performing beam failure (or link failure) detection by a mobile termination of the repeater (for a first cell); and
(being expected/allowed) performing forwarding by a forwarding entity of the repeater ((or being allowed) to turned on/forward) in case of beam failure (on the first cell).
2. The method according to supplement 1, wherein the first cell is a Pcell, or a PScell, or an Scell.
3. The method according to supplement 1 or 2, wherein the method further includes: performing beam failure recovery (BFR) by the repeater (NCR/NCR-MT).
4. The method according to supplement 3, the beam failure recovery includes: initiating random access (on the first cell), or transmitting an SR and/or an MAC CE for BFR (to a second cell).
5. The method according to supplement 3 or 4, wherein the method further includes:
(being expected/allowed) performing forwarding by the NCR-Fwd (by using a third beam), until the BFR is successful (or before the BFR is successful).
6. The method according to any one of supplements 1-5, wherein the method further includes:
(being expected/allowed) performing forwarding by the NCR-Fwd (by using a third beam) after the BFR is successful until first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied) (or therebefore).
7. The method according to any one of supplements 1-5, wherein the method further includes:
(being expected/allowed) performing forwarding by the NCR-Fwd (by using the third beam) after a first time period (such as after 28 symbols from a last symbol of a first PDCCH reception in a search space set provided by recoverySearchSpaceId for which the UE detects a DCI format with CRC scrambled by C-RNTI or MCS-C-RNTI) (until first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied) (or therebefore).
8. The method according to any one of supplements 1-7, wherein the method further includes:
performing forwarding by the repeater (by using a second beam) after first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied) (or therebefore).
8a. The method according to any one of supplements 1-8, wherein the repeater performs forwarding by using the second beam or the third beam after first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied).
9. The method according to any one of supplements 5-8a, wherein that the beam failure recovery is successful includes:
that (for CFRA) the NCR-MT detects DCI (format) with CRC scrambled by a C-RNTI or an MCS-C-RNTI or an RNTI for NCR in a search space (SS) provided by recovery SearchSpaceId (or receives a PDCCH transmission at the SS, the PDCCH transmission being addressed to the C-RNTI or the MCS-C-RNTI or the RNTI for NCR), and/or, receives a first PDCCH (the first PDCCH being addressed to the C-RNTI or the MCS-C-RNTI or the RNTI for NCR; for example, in the CFRA, the first PDCCH (NCR/NCR-MT) is after transmitting MsgA or PRACH, it is received during an RAR window), and/or, (during the beam failure recovery, or for the beam failure recovery, or initialized for the beam failure recovery), the (contention-free) random access procedure is (successfully) completed, and/or the beam failure recovery is (successfully) completed; or,
that (for CFRA) the NCR-MT detects DCI (format) with CRC scrambled by a C-RNTI or an MCS-C-RNTI or an RNTI for NCR in a search space (SS) provided by recovery SearchSpaceId (or receives a PDCCH transmission at the SS, the PDCCH transmission being addressed to the C-RNTI or the MCS-C-RNTI or the RNTI for NCR), and/or, receives a first PDCCH (the first PDCCH being addressed to the C-RNTI or the MCS-C-RNTI or the RNTI for NCR; for example, in 2-step CFRA, the first PDCCH is after transmitting MsgA (by NCR/NCR-MT), in 4-step CFRA, the first PDCCH is after transmitting Msg.3 (by NCR/NCR-MT), it is received during contention resolution window), and the contention resolution is successful, and/or, (during the beam failure recovery, or for the beam failure recovery, or initialized for the beam failure recovery), the (contention-based) random access procedure is (successfully) completed, and/or the beam failure recovery is (successfully) completed.
10. The method according to any one of supplements 6-9, wherein the first indication information is used to indicate/configure a control link beam (for configuring and/or activating a TCI state/SRI (SpatialRelationInfo) (for a PDSCH and/or a PDCCH and/or a PUCCH and/or an SRS), including RRC signaling, and/or an MAC CE, and/or DCI).
11. The method according to any one of supplements 6-10, wherein the first indication information includes:
an MAC CE activation command for a TCI state (or an activation for a TCI state) or tci-StatesPDCCH-ToAddList (−r17/r18) and/or tci-StatesPDCCH-ToReleaseList (−r17/r18) (of any parameter), and/or,
PUCCH resource(s) for PUCCH-SpatialRelationInfo (−r17/r18), and/or an (MAC CE) activation command for PUCCH-SpatialRelationInfo (−r17/r18), and/or,
tci-StatesToAddModList (−r17/r18) and/or tci-StatesToReleaseList (−r17/r18) (configured for a PSDCH/in PDSCH-Config), and/or,
dl-OrJointTCI-StateList (−r17/r18) and/or dl-OrJointTCI-StateToAddModList (−r17/r18) and/or dl-OrJointTCI-StateToReleaseList (−r17/r18) (configured for a PSDCH/in PDSCH-Config), and/or,
ul-TCI-ToAddModList, and/or,
second DCI (such as DCI formats 1_1/1_2, etc.) (used to indicate (or having indicated) unified TCI).
12. The method according to any one of supplements 6-11, wherein the method further includes:
determining the second beam (including an uplink beam and/or a downlink beam) (according to first indication information and/or the predefined rule) (or, the second beam is predefined (including being determined according to the first indication information and/or the predefined rule)).
13. The method according to any one of supplements 8-12, wherein the second beam includes:
a (downlink) beam determined by a QCL assumption of a CORESET with a minimum ID and/or an (uplink) beam determined by a spatial relationship of a PUCCH (in a CORESET configured for the first serving cell) with a minimum (PUCCH resource) ID; and/or,
(a downlink and/or an uplink beam determined by) an indicated unified TCI.
14. The method according to supplement 8 or 9, wherein the second indication information is used to indicate a backhaul link beam (such as an MAC CE).
15. The method according to supplement 8 or 8a or 14, wherein the second beam is indicated by the second indication information.
16. The method according to any one of supplements 6-9, wherein the method further includes: determining the second beam (according to the second indication information).
17. The method according to any one of supplements 6-9, wherein the third indication information is used to indicate the access link beam.
18. The method according to any one of supplements 6-9, wherein the third indication information includes: a periodic/semi-persistent access link beam indication (or provided by RRC signaling), an activation command (MAC CE/DCI) (for activating an access link beam indication), information for configuring/indicating (NCR/NCR-MT monitoring) first DCI, and first DCI (for indicating an access link beam).
19. The method according to any one of supplements 1-18, wherein the method further includes:
not monitoring (or not receiving) first DCI (format) and/or second DCI by the NCR-MT in case of beam failure, the first DCI being used to indicate the access link beam.
20. The method according to any one of supplements 1-19, wherein the NCR-MT does not monitor first DCI (format) during the beam failure recovery (or until or before the BFR is successful).
21. The method according to supplement 19 or 20, wherein the NCR-MT monitors the first DCI (format) after the BFR is successful.
22. The method according to supplement 19 or 20, wherein the NCR-MT does not monitor first DCI (format) until first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied) (or therebefore).
23. The method according to supplement 22, wherein the NCR-MT monitors first DCI (format) after first indication information (control link beam indication/configuration) and/or second indication information (or backhaul link beam configuration/indication) and/or third indication information (or access link beam configuration/indication) is/are received, and/or first indication information and/or second indication information and/or third indication information is/are applied (or beams indicated by the above indication information are applied).
24. The method according to any one of supplements 1-18, further including:
monitoring first DCI (format) by the NCR-MT in a case where the beam fails, the first DCI being used to indicate the access link beam.
25. The method according to any one of supplements 1-19, wherein the NCR-MT monitors first DCI (format) during the beam failure recovery (or until or before the BFR is successful).
26. The method according to any one of supplements 1-25, wherein the NCR-MT monitors first DCI when the beam fails and/or before the beam failure recovery.
27. A repeater, including a memory and a processor, the memory storing a computer program, and the processor being configured to execute the computer program to carry out the forwarding control method as described in any one of supplements 1-26.
1. A forwarding control method, applicable to a repeater, characterized in that the method includes:
performing beam failure (or link failure) detection by the repeater (for a first cell);
performing beam failure recovery (BFR) by a mobile termination (NCR-MT) of the repeater in case of beam failure (on the first cell); and
not performing forwarding by a forwarding entity (NCR-Fwd) of the repeater in a case where the BFR fails (or there exists an issue of random access).
2. A forwarding control method, applicable to a repeater, characterized in that the method includes:
receiving third indication information by the repeater; or,
not expecting by the repeater to receive the third indication information and/or not (expected) applying the third indication information by the repeater before the repeater has an (applicable) backhaul link beam.
3. The method according to supplement 2, wherein before the repeater has an (applicable) backhaul link beam, the method includes:
before determining the backhaul link beam (or receiving first indication information) (according to a predefined rule and/or first indication information), and/or,
before applying the determined backhaul link beam (according to predefined rule and/or the first indication information), and/or
before being configured with/indicated a backhaul link beam (or receiving second indication information), and/or
before applying the indicated backhaul link beam (or applying second indication information).
4. A repeater, including a memory and a processor, the memory storing a computer program, and the processor being configured to execute the computer program to carry out the forwarding control method as described in supplement 1 or 2 or 3.
5. An information transmission method, applicable to a network device, characterized in that the method includes:
transmitting third indication information by the network device; or,
not transmitting the third indication information by the network device before the repeater has an (applicable) backhaul link beam or a second time period before the repeater has an (applicable) backhaul link beam.
6. The method according to supplement 5, wherein the second time period includes a time needed by the repeater in applying the third indication information.
7. The method according to supplement 5, wherein the third indication information is used to indicate an access link beam.
8. The method according to supplement 5, wherein the third indication information includes: a periodic/semi-persistent access link beam indication (or provided by RRC signaling), an activation command (MAC CE/DCI) (for activating an access link beam indication), information for configuring/indicating (NCR/NCR-MT monitoring) first DCI, and first DCI (for indicating an access link beam).
9. A network device, including a memory and a processor, the memory storing a computer program, and the processor being configured to execute the computer program to carry out the information transmission method as described in any one of supplements 5-8.

1. A repeater, comprising:
a mobile termination (NCR-MT) configured to perform beam failure detection; and
a forwarding entity (NCR-Fwd) configured to cease forwarding in case of beam failure.

2. The repeater according to claim 1, wherein the NCR-MT performs beam failure recovery (BFR).

3. The repeater according to claim 1, wherein the NCR-Fwd cease forwarding until the BFR is successful.

4. The repeater according to claim 1, wherein the NCR-Fwd performs forwarding after the BFR is successful.

5. The repeater according to claim 1, wherein, after BFR is successful, the NCR-Fwd performs forwarding using a backhaul link beam indicated by a MAC CE for backhaul link beam indication received by NCR-MT before beam failure.

6. The repeater according to claim 1, wherein after a first time period after a first PDCCH, the NCR-Fwd performs forwarding.

7. The repeater according to claim 6, wherein the first PDCCH is used to determine that beam failure recovery is successful and/or is used to determine that a random access procedure is completed.

8. The repeater according to claim 4, wherein the NCR-Fwd performs forwarding by using a first beam, the first beam being identical to a beam used in a random access attempt/random access procedure.

9. The repeater according to claim 4, wherein the NCR-Fwd performs forwarding by using a first beam, the first beam including a downlink beam and/or an uplink beam.

10. The repeater according to claim 4, wherein the NCR-Fwd performs forwarding by using a first beam, the first beam being predefined or indicated.

11. The repeater according to claim 1, wherein the NCR-Fwd is turned off/does not perform forwarding before the BFR is successful until a first indication information and/or a second indication information and/or a third indication information is/are received, and/or the first indication information and/or the second indication information and/or the third indication information is/are applied.

12. The repeater according to claim 1, wherein the NCR-Fwd performs forwarding after a first indication information and/or a second indication information and/or a third indication information is/are received, and/or the first indication information and/or the second indication information and/or the third indication information is/are applied.

13. The repeater according to claim 1, wherein the NCR-Fwd performs forwarding by using a first beam or a third beam after a first indication information and/or a second indication information and/or a third indication information is/are received, and/or the first indication information and/or the second indication information and/or the third indication information is/are applied.

14. The repeater according to claim 2, wherein that the beam failure recovery is successful comprises:
that the NCR-MT detects DCI with CRC scrambled by a C-RNTI or an MCS-C-RNTI or an RNTI for NCR in a search space (SS) provided by recoverySearchSpaceId, and/or, receives a first PDCCH, and/or, a random access procedure is completed, and/or the beam failure recovery is completed; or,
that the NCR-MT detects DCI with CRC scrambled by a C-RNTI or an MCS-C-RNTI or an RNTI for NCR in a search space provided by recoverySearchSpaceId, and/or, receives a first PDCCH, and/or, contention resolution is successful, a random access procedure is completed, and/or the beam failure recovery is completed.

15. The repeater according to claim 11, wherein the first indication information is used to indicate/configure a control link beam.

16. The repeater according to claim 11, wherein the first indication information comprises:
an MAC CE activation command for a TCI state or tci-StatesPDCCH-ToAddList (−r17/r18) and/or tci-StatesPDCCH-ToReleaseList (−r17/r18), and/or,
PUCCH resource(s) for PUCCH-SpatialRelationInfo (−r17/r18), and/or an activation command for PUCCH-SpatialRelationInfo (−r17/r18), and/or,
tci-StatesToAddModList (−r17/r18) and/or tci-StatesToReleaseList (−r17/r18), and/or,
dl-OrJointTCI-StateList (−r17/r18) and/or dl-OrJointTCI-StateToAddModList (−r17/r18) and/or dl-OrJointTCI-StateToReleaseList (−r17/r18), and/or,
ul-TCI-ToAddModList, and/or,
a second DCI.

17. The repeater according to claim 11, wherein the second indication information is used to indicate a backhaul link beam.

18. The repeater according to claim 11, wherein the third indication information is used to indicate an access link beam.

19. The repeater according to claim 11, wherein the third indication information includes a periodic/semi-persistent access link beam indication, an activation command, information for configuring/indicating first DCI, and/or first DCI.

20. A communication system, comprising the repeater as claimed in claim 1.
